(19) United States
(12) Patent Application Publication
(10) Pub. No.: US 2021/0281667 A1
(43) Pub. Date: Sep. 9, 2021

(54) NAMED CONTENT FOR END-TO-END INFORMATION-CENTRIC IP INTERNET

(71) Applicant: The Regents of the University of California, Oakland, CA (US)

(72) Inventors: Jose Joaquin Garcia-Luna-Aceves, Santa Cruz, CA (US); Abdulazaz Albalawi, Santa Cruz, CA (US)

(21) Appl. No.: 17/249,574

(22) Filed: Mar. 5, 2021

Related U.S. Application Data
(60) Provisional application No. 62/985,665, filed on Mar. 5, 2020.
(60) Provisional application No. 63/084,356, filed on Sep. 28, 2020.

(51) Int. Cl. H04L 29/06; H04L 9/08; H04L 12/803; H04L 12/801

(52) U.S. Cl. CPC H04L 69/22; H04L 47/34; H04L 47/122; H04L 9/0827

(57) ABSTRACT

Techniques for information-centric transport include, in response to receiving content from a server process on a local node storing the content on the local node. The content comprises a plurality of chunks. A CNS-compatible name for the content is generated. Also, a plurality of chunk names is generated for the plurality of chunks. A manifest field is generated, which holds data that indicates the chunk names and data that indicates encoding of the chunks. The manifest field and the CNS-compatible name are caused to be stored. A data packet that includes, in a second reliable protocol payload, the manifest field and an node identifier for a node that stores the content is caused to be sent in response to a request for the manifest for the CNS-compatible name.

### CROSS-REFERENCE TO RELATED APPLICATIONS

This application claims benefit under 35 U.S.C. § 119(e) of Provisional Appln. 62/985,665, filed Mar. 5, 2020, and of Provisional Appln. 63/084,356, filed Sep. 28, 2020, the entire contents of each of which are hereby incorporated by reference as if fully set forth herein.

### BACKGROUND

Networks of general-purpose computer systems connected by external communication links are well known and widely used in commerce. The networks often include one or more network devices that facilitate the passage of information between the computer systems. A network node is a network device or computer system connected by the communication links. An end node is a node that is configured to originate or terminate communications over the network. An intermediate network node facilitates the passage of data between end nodes.

Communications between nodes are typically effected by exchanging discrete packets of data, called communication packets, or simply “packets,” herein. Information is exchanged within packets according to one or more of many well-known, new or still developing protocols. In this context, a protocol consists of a set of rules defining how the nodes interact with each other based on information sent over the communication links. Each packet typically comprises 1] header information associated with a particular protocol, and 2] payload information that follows the header information and contains information that may be processed independently of that particular protocol. In some protocols, the packet includes 3] trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different layer of detail for information exchange. The header for a particular protocol typically indicates a type for the next protocol contained in its payload. The higher layer protocol is said to be encapsulated in the lower layer protocol.

The headers included in a packet traversing multiple heterogeneous networks, such as the Internet, typically include a physical (layer 1) header, a data-link (layer 2) header, an internetwork (layer 3) header and a transport (layer 4) header, as defined by the Open Systems Interconnection (OSI) Reference Model. The OSI Reference Model is generally described in more detail in Section 1.1 of the reference book entitled Interconnections Second Edition, by Radia Perlman, published September 1999, which is hereby incorporated by reference as though fully set forth herein. Some protocols pass protocol-related information among two or more network nodes in special control packets that are communicated separately, and which include a payload of information used by the protocol itself rather than a payload of data to be communicated for another protocol or application. These control packets and the processes at network nodes that utilize the control packets are said to be in another dimension, a “control plane,” distinct from the “data plane” dimension that includes the packets with payloads for other applications at the end nodes.

The internetwork header (layer 3) provides information defining the source and destination address within the network. Notably, the path may span multiple physical links. The internetwork header may be formatted according to the Internet Protocol (IP), which specifies IP addresses of both a source and destination node at the end points of the logical path. Thus, the packet may “hop” from node to node along its logical path until it reaches the end node assigned to the destination IP address stored in the packet's internetwork header.

The transport header (layer 4) provides information defining the relationship between one or more packets used for exchanging data between application programs executing on the end nodes; and ensures all the data to be transmitted by the application program on one end node are received by the application program other end node. The header, its control packets and its rules constitute a transport protocol. The best-known transport protocol of the Internet Protocol suite is the Transmission Control Protocol (TCP). It is used for connection-oriented transmissions, whereas the connectionless User Datagram Protocol (UDP) is used for simpler messaging transmissions. TCP is the more complex protocol, due to its stateful design incorporating reliable transmission and data stream services. Together, TCP and UDP comprise essentially all traffic on the Internet and are the only protocols implemented in every major operating system.

The next layer is the application layer (layer 5) which operates on the end nodes to generate or use the data transported. This layer includes World Wide Web browsers and other server and client applications.

While each is suitable for its intended purpose, the complexity of TCP to determine and maintain state information on specific connections between specific application processes on specific end nodes can limit throughput, such as when streaming content, while UDP is lacking in reliability and error recovery.

### SUMMARY

Techniques are provided for an information-centric reliable protocol that is simpler than TCP with greater throughput potential and that still has superior reliability for extensive data exchange compared to UDP. This information-centric reliable protocol (called herein Named Content Reliable Protocol, NCRP, or, as a modifier, simply Named Content Transport, NCR) has profound implications for improved simplicity, efficiency, flexibility, and robustness.

According to a first set of embodiments, a content consumer method executed on a processor serving as a local node in a digital communications network includes sending a request packet from a client process on the local node to a server process on a remote node for content that includes multiple chunks. The method also includes receiving from the remote node a manifest packet that includes a first reliable protocol payload that indicates: a name for the content; a method to decode the content after the content is delivered in coded form; and a list of chunk names and corresponding sizes of the plurality of chunks. The method further includes sending, in response to receiving the manifest packet, an interest packet that includes a second reliable protocol payload that indicates the name for the content and chunk names for one or more missing chunks of the plurality of chunks, wherein a missing chunk has not been successfully received by the client process.

In some embodiments of the first set, at least one of the method to decode the content or the list of chunk names is encrypted with a key unknown at any intermediate node in the digital communications network.

In some embodiments of the first set, the method still further includes, in response to sending the interest packet, receiving a data delivery packet that includes a third reliable protocol payload that indicates the name for the content and one coded chunk of the one or more missing chunks. In some of these embodiments, the one coded chunk is encrypted with a key unknown at any intermediate node in the digital communications network.

In some embodiments of the first set, the method still further includes controlling a rate of sending the interest packet based on congestion in the network. In some of these embodiments, controlling the rate of sending the interest packet includes maintaining a value for a congestion window parameter, wherein the value defines a maximum number of outstanding interest packets allowed to be sent without receiving corresponding data delivery packets.

According to a second set of embodiments, a content producer method executed on a processor serving as a local node includes, in response to receiving content from a server process on the local node, storing the content on the local node in a content store. The content includes multiple chunks of data. The method also includes generating a content name server (CNS) compatible name for the content and generating chunk names for the multiple chunks. Further, the method includes generating a manifest field that holds data that indicates the chunk names and a method of encoding the chunks. Still further, the method includes causing a CNS node to store the manifest field and the CNS-compatible name. The method further causes the CNS node to send a data packet that includes, in a second reliable protocol payload, the manifest field and a node identifier (such as a network address) for a node that stores the content in response to a request for the manifest for the CNS-compatible name.

In some embodiments of the second set, the method to decode the content includes data that indicates a number of chunks and an order for requesting the multiple chunks. In some embodiments of the second set, the name for the content is unique within the digital communications network. In some embodiments of the second set, the name for the content includes a port number and IP address of the application on the local node.

In some embodiments of the second set, the local node is the CNS node. In these embodiments, the method includes, in response to receiving a request packet from a client process on a remote node for content, sending to the client process a manifest packet that includes a first reliable protocol payload that indicates the name for the content, a method to decode the content after the content is delivered in coded form, and a list of chunk names and corresponding sizes of the multiple chunks.

In some embodiments in which the CNS node is the local node, the method also includes, in response to receiving an interest packet from the client; sending to the client process a data delivery packet. The interest packet includes a second reliable protocol payload that holds data that indicates the name for the content and one or more chunks of interest of the multiple chunks. The data delivery packet includes a third reliable protocol payload that indicates the name for the content and one coded chunk of the one or more chunks of interest.

In some embodiments in which the CNS node is the local node, the first reliable protocol payload also holds data that indicates a list of Internet protocol (IP) addresses of other nodes from which the content can be requested.

In some embodiments in which the CNS node is the local node, at least one of the method to decode the content after the content is delivered in coded form or the list of chunk names is encrypted with a decryption key known to the client process.

In some embodiments in which the CNS node is the local node, the second reliable protocol payload also holds data that indicates one or more chunks of the plurality of chunks, which chunks have been successfully received by the client process.

In some embodiments of the second set, the CNS node is a modified Domain Name Server (DNS) node that is not the local node. In some of these embodiments, the manifest field is encrypted with a key known to a client process at a remote node but not known to the CNS node.

In some embodiments of the second set using the modified DNS, in response to receiving, from a remote node hosting a client process, an interest packet that includes a third reliable protocol payload that indicates the CNS-compatible name for the content and a first chunk name for a first chunk of the multiple chunks, the method includes sending to the remote node a data delivery packet that includes a fourth reliable protocol payload that indicates the CNS-compatible name for the content and the first chunk encoded. In some embodiments of the first set, the manifest field is encrypted with a key known to a client process at the remote node but not known to the CNS node.

In a third set of embodiments, a method executed on a processor serving as a local content name server (CNS) node in a digital communications network, includes receiving, from a first remote node, a manifest registration packet that includes a first reliable protocol payload. The first reliable protocol payload holds data that indicates a CNS-compatible name for content and a manifest field. The content includes multiple chunks. The manifest field holds data that indicates chunk names and metadata that indicates encoding of the chunks. The method includes storing locally in a named content delivery data structure the CNS-compatible name in a content name field, the manifest field in a manifest field, and a node identifier of the first remote node in an address field. In some of these embodiments the CNS node is a Domain Name Server (DNS) node. In some embodiments of the third set, the manifest field is encrypted with a key known to a client process at the second remote node but not known to the local CNS node.

In some embodiments of the third set, the method also includes, in response to receiving, from a second remote node different from the first remote node, a request for the manifest for the CNS-compatible name in a second reliable protocol payload, sending to the second remote node a manifest response packet. The manifest response packet includes, in a third reliable protocol payload, the manifest field and a node identifier for a node that stores the content.

In some embodiments of the third set, the method also includes, in response to receiving, from a second remote node different from the first remote node, a data packet with the CNS-compatible name in a second reliable protocol payload, adding an IP address of the second remote node to the named content delivery data structure. In some of these embodiments, the method further includes, in response to receiving, from a third remote node different from the first remote node and the second remote node, a request for the manifest for the CNS-compatible name in a third reliable protocol payload, sending to the third remote node a manifest response packet that includes a fourth reliable protocol payload. The fourth reliable protocol payload includes the manifest field and a node identifier for a node that stores the content. The node identifier is selected from the local named content delivery data structure, wherein the node identifier has a lowest cost among all addresses in the named content delivery data structure for communicating a data packet to the third remote node.

In a fourth set of embodiments, a method executed on a processor serving as a named content prosy local node in a digital communications network, includes receiving, from a client process on a first remote node, an interest packet that includes an Internet Protocol (IP) header that indicates a different second remote node and a first reliable protocol payload that indicates a name for content The content includes multiple chunks. The interest packet also includes data that indicates one or more missing chunks of the plurality of chunks, wherein a missing chunk has not been successfully received by the client process. Further the method includes determining whether the missing chunk associated with the name for the content is stored locally. If the missing chunk associated with the name for the content is not stored locally, then the method still further includes forwarding the interest packet to the second remote node. On the other hand, if the missing chunk associated with the name for the content is stored locally, then, instead of forwarding the interest packet to the second remote node, sending to the first remote node a data delivery packet that includes a second reliable protocol payload that indicates the name for the content and the missing chunk.

In some embodiments of the fourth set, the method still further includes upon receiving a data delivery packet originating from the second remote node that includes a third reliable protocol payload that indicates the name for the content and one chunk, storing and forwarding the chunk. Storing includes storing locally the one chunk in association with the name for the content. Forwarding includes forwarding the data delivery packet according to a destination address in an IP header of the data delivery packet.

In a fifth set of embodiments, a non-transitory computer readable medium includes a manifest data structure that includes a first field that holds data that indicates a content name for content that includes multiple data chunks. The manifest data structure also includes a second field that holds data that indicates multiple names for the corresponding multiple data chunks. The manifest data structure also includes a third field that holds data that indicates a method for decoding the plurality of chunks. In some embodiments of the fifth set, the manifest data structure further includes a fourth field that indicates a size for each chunk of the multiple chunks. In some embodiments of the fifth set, the manifest data structure further includes a fourth field that indicates node identifiers of nodes that hold the content with the content name. In some embodiments of the fifth set, at least one of the second field or the third field is encrypted.

In other sets of embodiments, a non-transitory computer-readable medium or an apparatus or system is configured to perform one or more steps of one or more of the above methods or to provide data structures to support one or more of the above methods.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1 is a block diagram that illustrates an example cloud-based system, according to an embodiment;

FIG. 2A and FIG. 2B are block diagrams that illustrate example communication packets with layer 3 and layer 4 headers, according to an embodiment;

FIG. 2C is a block diagrams that illustrates an example named content store data structure, according to an embodiment;

FIG. 2D is a block diagrams that illustrates an example named content delivery data structure, according to an embodiment;

FIG. 2E is a block diagram that illustrates an example pending interest table (PIT) data structure, according to an embodiment;

FIG. 3A through FIG. 3D are flow diagrams that illustrate example methods on various nodes in a data communications network, according to various embodiments;

FIG. 4A is a block diagram that illustrates an example architecture for named content delivery, according to an embodiment;

FIG. 4B is a block diagram that illustrates example network traffic using named content reliable protocol (NCRP), according to an embodiment;

FIG. 4C is a block diagram that illustrates example HTTP network traffic using NCR, according to an embodiment;

FIG. 4D is a block diagram that illustrates example network traffic using named content reliable protocol (NCRP) and a NCR proxy, according to an embodiment;

FIG. 5A is a block diagram that illustrates an example architecture for a named content producer using a separate name server, according to an embodiment;

FIG. 5B is a block diagram that illustrates an example architecture for a named content consumer using a separate name server, according to an embodiment;

FIG. 5C is a block diagram that illustrates example network traffic using a separate name server, according to an embodiment;

FIG. 5D is a block diagram that illustrates example network traffic using partial encryption for proxy servers, according to an embodiment;

FIG. 6A through FIG. 6C are plots that illustrate example performance compared to TCP, according to an embodiment;

FIG. 7 is a plot that illustrates example performance of a different measure compared to TCP, according to an embodiment;

FIG. 8 is a block diagram that illustrates example network topology with proxy content servers according to an embodiment;

FIG. 9 is a plot that illustrates example performance, according to various embodiments;

FIG. 10A and FIG. 10B are plots that illustrate example performance using cached and non-cached CNS records, respectively, according to various embodiments;

FIG. 11A and FIG. 11B are plots that illustrate example throughput performance over TCP using cached and non-cached chunks, respectively, according to various embodiments;

FIG. 12 is a block diagram that illustrates a computer system upon which an embodiment of the invention may be implemented;

FIG. 13 is a block diagram that illustrates a chip set upon which an embodiment of the invention may be implemented; and

FIG. 14 is a block diagram that illustrates example components of a mobile terminal (e.g., cell phone handset) for communications, which is capable of operating in the system of FIG. 1, according to one embodiment.

### DETAILED DESCRIPTION

A method and apparatus are described for information-centric data delivery at layer 4. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

While various embodiments are described in the context of exchanging named content for an application-level process (layer 5), embodiments are not limited to that context. In some embodiments the named content is exchanged for any nexus of remote processes, e.g., a client process and a server process. Those client and server processes can be at the link, network, transport or application layers, e.g., using control plane packets at any of those layers with payloads similar to the named content reliable payloads described below for the transport layer.

### 1. Overview

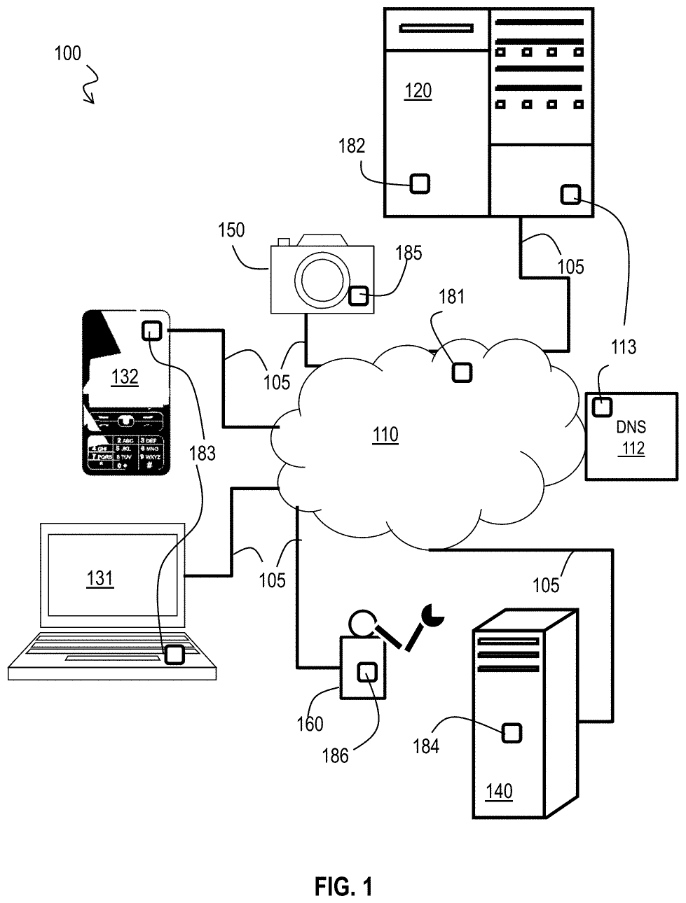

FIG. 1 is a block diagram that illustrates an example cloud-based system 100, according to an embodiment. The system includes a network 110 of interconnected communication devices on one or more private or public networks using wired or wireless single channel or multichannel connections 105. User devices such as laptop 131 and mobile device 132 are connected to the network using one or more wired or wireless single channel or multichannel connections 105. One or more server nodes 120, often at different locations, also using one or more connections 105, provide services for devices connected to the system 100, and store data in one or more special storage nodes 140, often at different locations, also using one or more connections 105. In addition, in some systems, one or more sensors 150 (such as digital cameras, telescopes, laser and radar detectors, medical imagers, etc.) respond to physical phenomena with signals that are converted to data transmitted over connections 105 to other devices in the system 100. In addition, in some systems, one or more actuators 160 (such as assembly line robots, 2D and 3D printers, lasers, radiation sources, etc.) produce physical phenomena in response to signals received as data transmitted over connections 105 from other devices in the system 100. Each of these components include one or more software modules that operate the device and communicate with other devices in the systems, as represented by the module 181 for the network 110, module 182 for server(s) 120, module 183 for user device laptop 131 or mobile device 132, module 184 for storage node(s) 140, module 185 for sensor(s) 150, and module 186 for actuator(s) 160. The software modules 181, 182, 183, 184, 185 and 185 are collectively referenced herein as software modules 180 and are configured to perform one or more steps of the methods described hereinafter.

According to the client-server model, a client process sends a message including a request to a server process, and the server process responds by providing a service. The server process may also return a message with a response to the client process. Often the client process and server process execute on different computer devices, called hosts or nodes, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, but not limited to those reasons.

A resource in the system is given a name called a universal resource locator (URL) that is unique among all resources on all the nodes in system 100. A Domain Name Server (DNS) node 112 holds data that translates a domain name portion of the URL into an internet address (such as an Internet Protocol address, abbreviated IP address) of a node that is responsible for that domain name. Resources at that node are identified by node-specific resource names that are unique at that node; and, the node specific resource names make up the remainder of the URL.

According to various embodiments, a content name server (CNS) node such as a layer 5 application node 120 or modified DNS node 112, includes a Named Content Transport module 113, including data structures called named content delivery data structures, that support a Named Content Reliable Protocol (termed NCRP) for transporting named content between client processes 183 and server processes 182, each of which is modified to use the NCRP. In some embodiments, one or more non-CNS network nodes serve as NCRP proxies and use network software 181 also modified to use the NCRP.

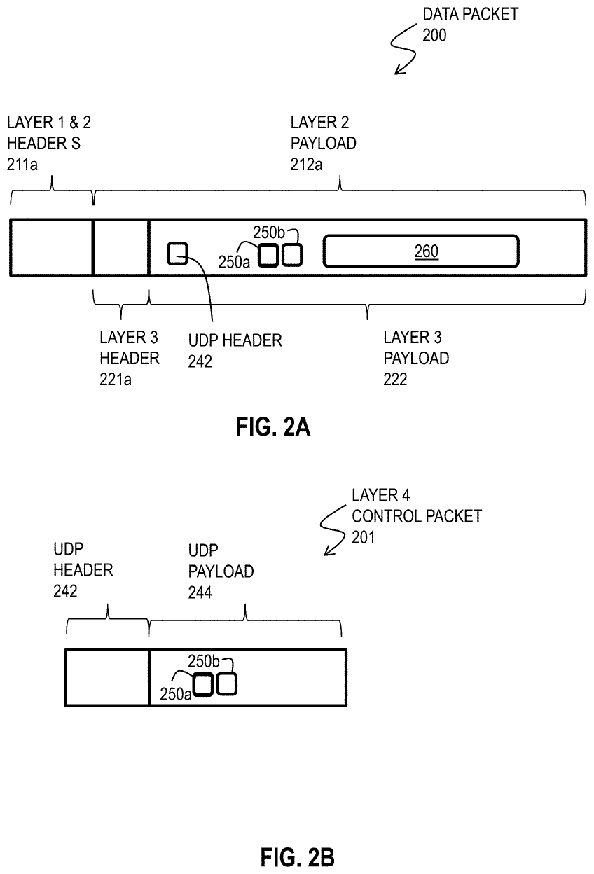

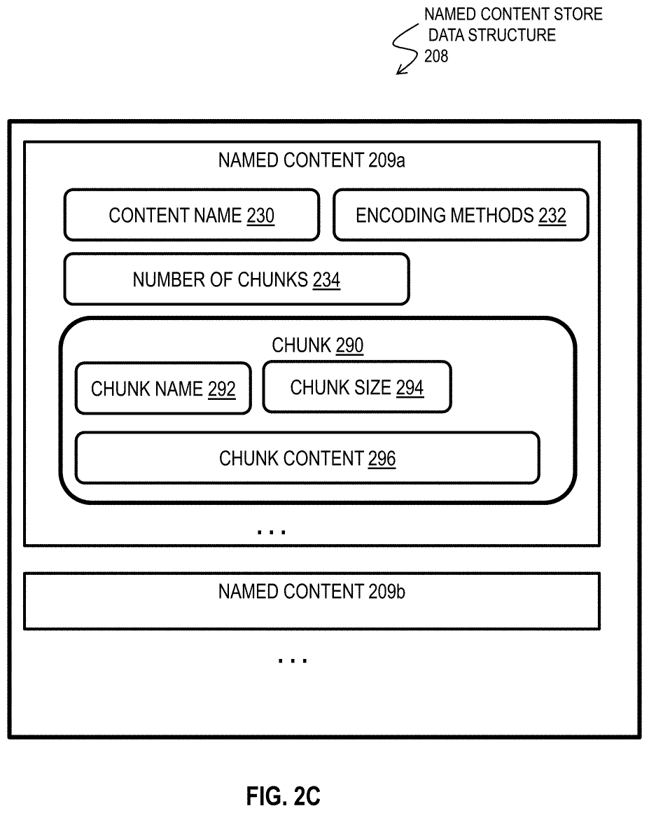

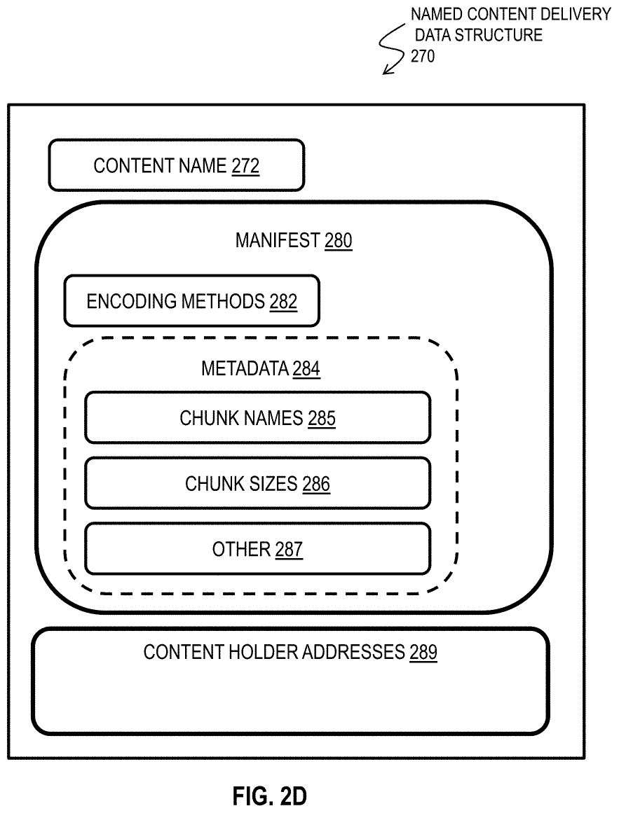

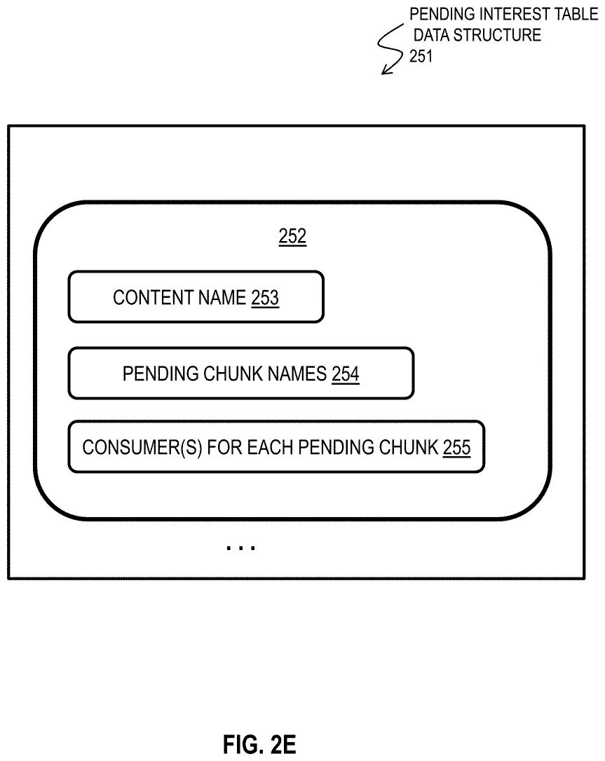

FIG. 2A and FIG. 2B are block diagrams that illustrate example packets with layer 3 and layer 4 headers, according to an embodiment. FIG. 2A illustrates an example data packet 200 with data provided for a Layer 4 or higher layer protocol, including various transport protocols. Such data packets 200 include headers 211a made up of a series of bits that indicate values for various Layer 1 and Layer 2 fields, and a Layer 2 payload 212a. The Layer 2 payload 212a includes a Layer 3 header 221a that is made up of a series of bits that indicate values for various Layer 3 fields (such as IP fields for source and destination IP addresses), and a Layer 3 payload 222. The Layer 3 payload 222 includes a series of bits that indicate values for the various fields of the header and payload of the higher layer protocols encapsulated by the Layer 3 protocol. No further protocol needs to be illustrated to describe the various embodiments.

The IP (Layer 3) payload includes a layer 4 transport protocol header 242 and a reliable protocol payload with some extended fields for the NCR protocol, including a name field 250a holding data that indicates a CNS-compatible name for application layer data to be transported, and second field 250b holding data that indicates the type of message or the name of at least one chunk of the application data. Here a chunk is a portion of the application data to be sent in a set of one or more communication packets. In a data delivery packet, the reliable protocol payload includes a coded data chunk in NCDP field 260. According to various embodiments, in a manifest delivery packet, the reliable protocol payload includes a manifest field in field NCDP 260 that holds data that indicates names, sizes and encoding of data in one or more chunks of the named content. In some embodiments, both the manifest field and the coded data chunk are each encrypted in a way that can only be decrypted at a client and server process using keys shared by those two end point processes. In some embodiments, the chunk name portion of field 250b is not so encrypted, or is encrypted with a key known to at least one intermediate node called a proxy server as well as known to the client process and known to the server process.

FIG. 2B illustrates an example control plane packet 201 for the Layer 4 protocol. As for the data packet 200, the control plane packet 201 includes a transport protocol header 242 and transport protocol payload 244. However here, the transport protocol payload 244 only holds NCRP data and no chunk field 260. This kind of packet is used to communicate information just used by the NCRP. Example NCRP control packets include a manifest packet and a chunk request packet, the latter also called an interest packet herein. As depicted in this NCRP packet, according to various embodiments, the reliable protocol payload includes the application data name field 250a and second field 250b, described above, such as a field holding data that indicates manifest in a manifest control packet or the chunk name of the requested chunk in an interest packet.

FIG. 2C is a block diagram that illustrates an example named content store data structure 208, according to an embodiment. This data structure 208 is generated by the NCRP process 182 at server node 120 in response to data provided by the layer 5 application process (not shown) on the same node 120, e.g., through the application programming interface (API) of the server. This NCRP process 182 is called the content producer (or simply producer) hereinafter. At least a portion of this data structure 208 is reproduced by the NCRP process 183 for use by the client process (not shown) at the client node, e.g., 131 or 132, for the application process producing the content on the server node 120. This process 183 is called the content consumer (or simply, consumer) hereinafter. The content consumer 183 then passes the content on to the client process on the same node, e.g., through the client process application programming interface (API) of the client. For each different instance or call of each different application program on the server node 120, the NCRP process 182 generates a different named content record, such as named content records 209a and 209b, among others indicated by ellipsis, collectively called herein named content records 209.

Each named content record 209 includes a content name field 230, an encoding methods field 232, a number of chunks field 234, and two or more chunk fields indicated by field 290 and ellipsis collectively referenced as chunk fields 290. The content name field 230 holds data that indicates a name for the content produced by the local application program on server node 120. The content name is generated to be unique over the system 100 and appropriate for including in each NCRP packet in field 250a depicted in FIG. 2A and in FIG. 2B. The encoding methods field 232 holds data that indicates how each chunk of data is packed into a chunk field, e.g., what parameter occupies which bits and how values of certain units are biased or offset as desired to fit into the chunk field. In some embodiments, the encoding methods field 232 includes data that indicates whether the chunk field, or any other field, is encrypted for transport over the network 110. The number of chunks field 234 holds data that indicates how many chunk fields are involved in transporting all the content produced by the local server.

Each chunk field 290 includes a chunk name field 292, a chunk size field 294 and a chunk content field 296. The chunk name field 292 includes data that indicates a unique name for the chunk. In some embodiments, the unique chunk name is an extension that can be added to the content name in field 230. Thus, the chunk name is desirably unique among all the chunks in one named content record 209. In some embodiments, the chunk name also indicates the order for the chunk within the collection of chunks; and, in some such embodiments the chunk name includes a place number for the chunk in a desired order. The chunk size field 294 holds data that indicates the size of the chunk, e.g., in umber of bits or bytes. In some embodiments all chunks for one named content record 209 are the same size and field 294 is omitted. In such embodiments, the common size can be indicated by data in the encoding methods field 232. The chunk content field 296 holds data that indicates the contents of the chunk encoded as indicated in the encoding methods field 232. In many embodiments, the chunk content field 296 holds data that is not yet encrypted for transport.

FIG. 2D is a block diagram that illustrates an example named content delivery data structure 270, according to an embodiment. The named content delivery data structure 270 is generated by content producer 182 at server 120 in response to data provided by the layer 5 application process (not shown) on the same node 120, concurrent with or after generating the named content record 209 for the corresponding content. The named content delivery data structure 270 is formed to notify clients for the application content so the NCRP process 183 on the client node can ensure receipt of all the chunks. The manifest is published by sending the fields of the data structure 270 to a Content Name Server (CNS) 113 in response to a request by a client on a client node (131 or 132) for the content from the server node 120. In some embodiments, the CNS 113 has the responsibility for determining the unique content name. In some embodiments, the CNS 113 is on the server node 120; and, in other embodiments, the CNS 113 is on a different node, such as Domain Name server (DNS) node 112, which has a similar process already for managing unique domain names across the system 100.

In the illustrated embodiment, the named content delivery data structure 270 includes a content name field, a manifest field 280 and a content holder addresses field 289. The content name field 272 holds data that indicates the unique content name that is currently unique over the system 100. This data is consistent with that in field 230 of the content store and with that put into NCRP packets in field 250a. The manifest field 280 includes one or more fields to be sent to the NCRP process 183 on the client node (e.g., node 131 or 132). In some embodiments, one or more fields in the manifest field 280 hold data encrypted with a key known only at the producer 182 and consumer 183, or also at one or more proxy NCRP processes 181. The content holder addresses field 289 holds data that indicates the node identifiers (such as IP addresses) of nodes that hold copies of the named content, at least for one or more chunks. This saves network congestion by allowing traffic to be directed to nearby proxy servers that have already passed some or all of the named content.

In the illustrated embodiment, the manifest field 280 includes the encoding methods field 282, a chunk names field 285, a chunk sizes field 286 and an optional other field 287. The encoding methods field 282 hold data that indicates the encoding methods for the named content indicated in field 272, and is consistent with the data in field 232, such as being an encrypted version of that data. The chunk names field 285 hold data that indicates the chunk names for the named content indicated in field 272, and is consistent with the data in field 292 for all chunk records, such as being an encrypted version of that data. The chunk sizes field 286 hold data that indicates the chunk sizes for the named content indicated in field 272, and is consistent with the data in field 294 for all chunk records, such as being an encrypted version of that data. The optional other field 287 hold data that indicates other information about the named content indicated in field 272, such as the number of chunks in field 234, and may be an encrypted version of that data. In some embodiments, some manifest fields are collected into a metadata field 284. For example, the fields in the metadata field 284 are all encrypted for transport, while any fields outside the metadata field 284 are not encrypted. Any use of encryption may be used in various embodiments. The chosen method for controlling both content group keys and data encoding can increase the level of privacy by preventing consumers retrieving the same content from being able to identify other members in the same group while preventing caches from being able to understand cached content.

FIG. 2E is a block diagram that illustrates an example pending interest table (PIT) data structure 251, according to an embodiment. This data structure 251 is generated by the layer 4 NCRP process 181 at an intermediate network node serving as a proxy node. The PIT is generated in response to interest in named content from a NCR consumer process 183. For each different named content for which the NCRP process 181 serves as a proxy, the process 181 generates a different PIT record, such as PIT record 252, among others, if any, indicated by ellipsis, collectively called herein PIT records 209. Each PIT record includes a content name field 253 holding data that indicates the content name for which the process 281 serves as proxy. Each PIT record 252 also includes a pending chunk names field 254 that holds data that indicates one or more, encrypted or unencrypted chunk names for which the proxy NCRP process 181 has already sent an interest packet but not yet received the corresponding chunk. In some embodiments, each PIT record 252 also includes the names of all consumers requesting the chunk name in interest messages received by the proxy in field 255. In some embodiments, the PIT allows a proxy to aggregate Interests of the same content to prevent sending duplicate Interests to the server. In some embodiments, the PIT, doesn't indicate the consumer. In some such embodiments, if two interest packets request the same content, both of the interest packets will be forwarded to the server if the content doesn't exist in the proxy's cache.

Although processes, equipment, and data structures are depicted in the attached drawings as integral blocks in a particular arrangement for purposes of illustration, in other embodiments one or more processes or data structures, or portions thereof, are arranged in a different manner, on the same or different hosts, in one or more databases, or are omitted, or one or more different processes or data structures are included on the same or different hosts.

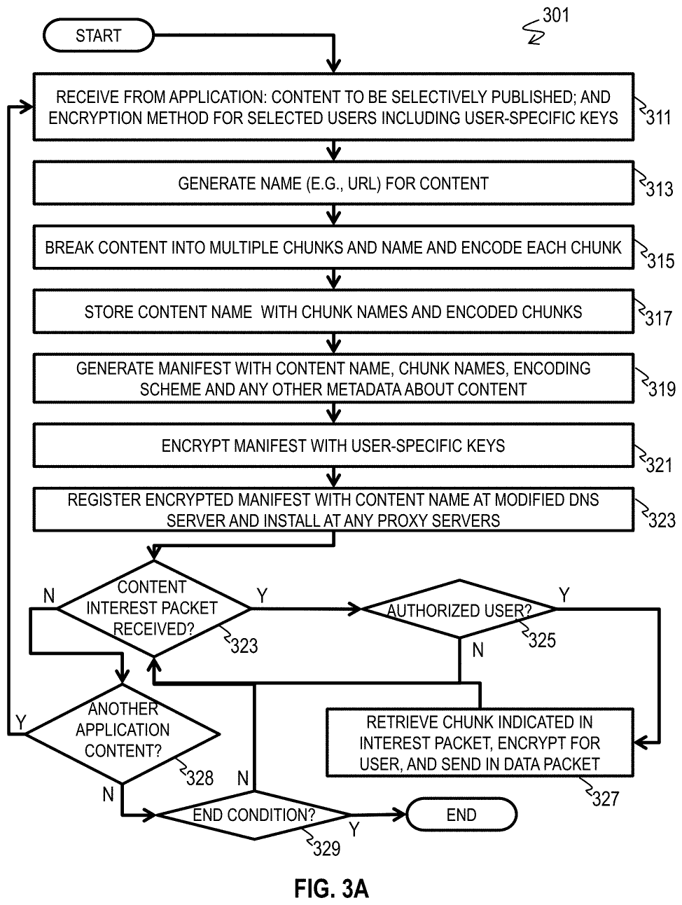

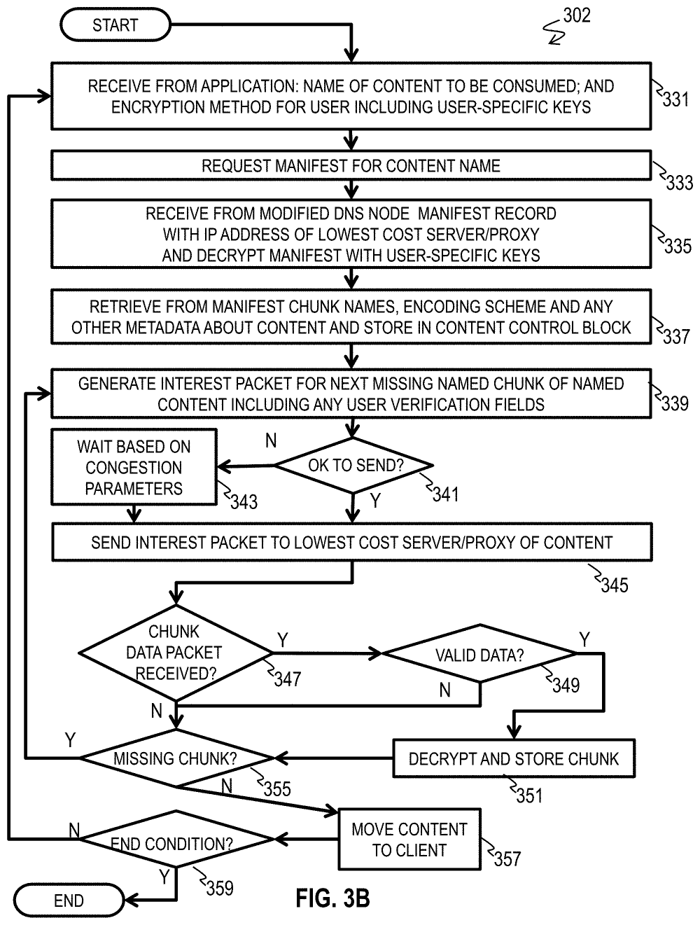

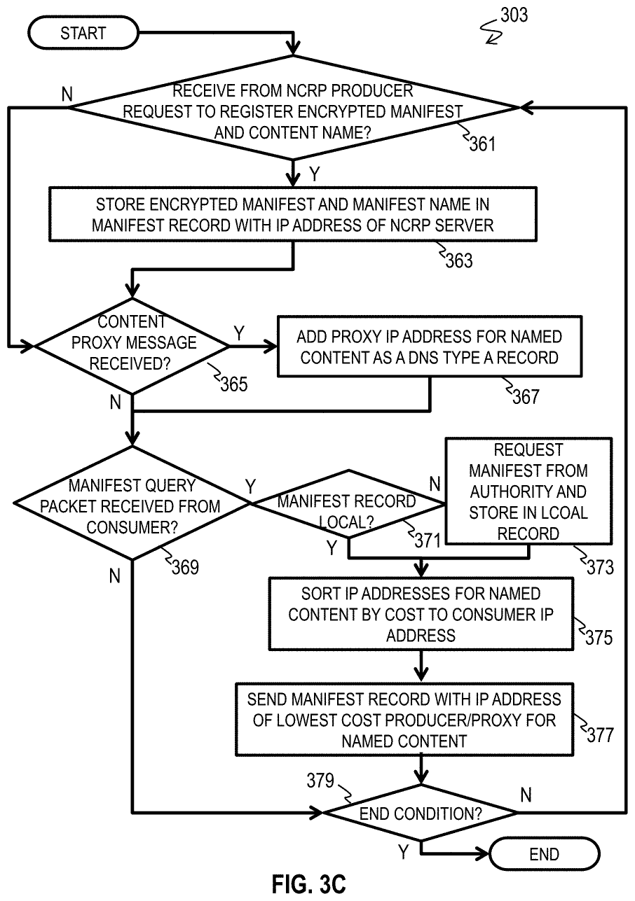

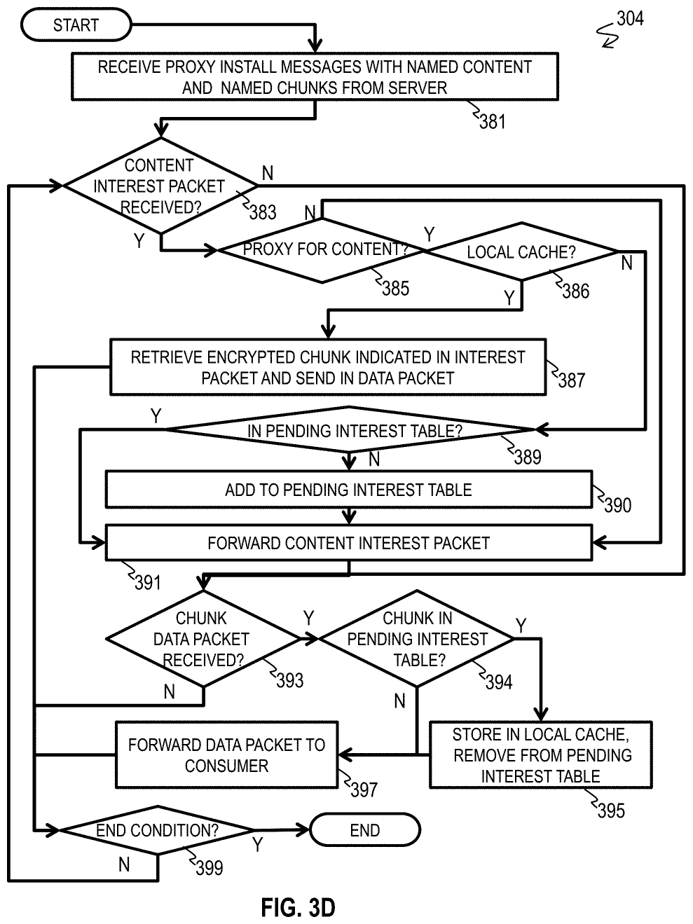

FIG. 3A through FIG. 3D are flow diagrams that illustrate example methods on various NCRP nodes in a data communications network, according to various embodiments. Although steps are depicted in these flow charts as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

FIG. 3A depicts an example method 301 at a NCRP data producer node (herein simply called producer), e.g., module 184 in node 140, or module 182 in node 120, both depicted in FIG. 1. In step 311, the producer receives, from a server process (not shown) on the same node, information content (also simply called content hereinafter) to selectively published to one or more consumers (also called data users, herein). Also received in step 311 is any encryption method and parameters used to secure data transport to the selected consumers, e.g., using user-specific keys or user group-specific keys. Further details for securing data according to some embodiments are described in the Example Embodiments Section.

In step 313 a name is generated for the content. In various embodiments, the content name is associated with one or more node identifiers at a dedicated server called a content name server (CNS) 113. In some embodiments the CNS 113 generates a name that is unique over the system 100. In some example embodiments, a DNS node 112 is modified slightly to support the NCRP as the node for CNS 113; and, the name generated for the content is a DNS-compatible name, such as a URL. Thus, the method generates, at content name server (CNS), a CNS-compatible name for the content. In some embodiments, this CNS-compatible name is returned in a control plane packet from a separate CNS, such as the modified DNS, to the content producer to add to the content store and transport data structures 208 and 270, respectively, at that node.

In step 315, the content is broken up into one or more chunks that can each be readily fit inside a single communications packet in a packet switched network, such as the Internet. Each chunk is given a unique name at the producer. Thus, the method generates a plurality of chunk names for the plurality of chunks. In some embodiments, step 315 includes encoding the chunks in any known manner, e.g., to compress the chunks to use less space. In step 317, the chunks are stored with their names and the content name in a content store data structure, such as data structure 208 depicted in FIG. 2C, at the producer node. Thus, the method stores the application data on the local node.

In step 319 a named content delivery data structure 270 is generated that holds manifest field 280 that indicates chunk names infield 285 and other metadata 284 about the content, including chunk size or sizes in field 286, encoding scheme in field 282 and other metadata in field 287 about content, such as indicated in the Example Embodiments Section. Thus, the method generates a manifest field that holds data that indicates the chunk names and metadata that indicates encoding of the chunks. In some embodiments, the manifest is named with the content name, e.g., manifest.URL where ULR is the content name. In some embodiments the manifest is encrypted in step 321 so that metadata about the content and chunks is not visible to any intermediate nodes in the network 110, including the separate node for the CNS, if any. Thus, the manifest field is encrypted with a key known to a client process at the remote node but not known to the separate CNS node.

In step 323, the manifest is registered at a content name server (CNS) 113, e.g., internally on the same node as the producer or by sending the manifest in field 260 of a reliable protocol payload of data packet 200 to a separate node such as DNS node 114. Thus, in some embodiments, the method includes sending the manifest in a first reliable protocol payload to a CNS node configured to store the manifest field and store the CNS-compatible name in a content name field. In some embodiments, step 323 includes installing one or more nodes as proxy servers by sending those proxy severs the CNS-compatible content name. Those proxy servers will then act based on receiving any traffic for that named content, as described in FIG. 3D. As a result of step 323, the network is now configured for processing traffic related to the named content.

In the next three steps, the content producer responds to a request for a chunk of the named content. In step 323 it is determined if the content producer receives a named content interest control packet. If so, then in step 325, it is determined if the client that sent the interest packet is an authorized consumer. Any method may be used, as described in more detail in the Example Embodiments Section. If the requesting client is from an authorized consumer, then, in step 327, the requested chunk is retrieved from the content store, encrypted if desired, and sent to the requesting node in a data packet, such as packet 200 in which the payload includes the encoded, and possibly encrypted, chunk in field 260. Thus, the method includes, in response to receiving, from a remote node hosting a client process, an interest packet that includes a third reliable protocol payload that indicates the CNS-compatible name for the application data and a first chunk name for a first chunk of the plurality of chunks; sending to the remote node a data delivery packet that includes a fourth reliable protocol payload that indicates the CNS-compatible name for the application data and the first chunk encoded (or encoded and encrypted).

If the client is not an authorized consumer, or if the chunk has been sent to an authorized consumer, control passes back to step 323 to receive the next interest packet. If an interest packet is not received, control passes to step 328. In step 328, it is determined if another application is sending content to be selectively published. If so, control passes back to step 311 and following steps, as described above. If not, control passes to step 329 to determine if end conditions are satisfied for terminating the process. If not, control passes back to step 323 to wait for the next interest packet. Otherwise the process ends.

FIG. 3B depicts an example method 302 at a NCRP consumer node (herein simply called consumer), e.g., module 183 in node 132 depicted in FIG. 1. In step 331, the consumer receives from a client process a name for content to be consumed. Also received in step 331 is any encryption method and parameters used to secure data transport from the producer, e.g., using user-specific keys or user group-specific keys. Further details for securing data according to some embodiments are described in the Example Embodiments Section.

In step 333, the consumer requests the manifest for the named content. For example, the consumer sends a NCRP control packet 201 requesting a manifest. In response, in step 335, the consumer receives from the CNS node, such as the modified DNS node, a named content delivery data structure with the node identifier (e.g., IP address) of a producer node or proxy node where the content can be obtained, e.g., in data packet 200 with the manifest in field 260 of the reliable protocol payload. In some embodiments with not only the producer but also one or more proxies, the node identifier can be the node identifier that involves the lowest cost for data communications, such as the shortest geographical distance or fewest network hops or least congestion, using any metric of cost. If the manifest field is encrypted, step 335 includes decrypting the manifest field using the user-specific, or user group-specific, keys, as described in more detail in the Example Embodiments Section.

In step 337, the consumer extracts from the manifest the names of the chunks, and the encoding scheme and any other metadata in the manifest, such as the order for the chunk names; and the consumer stores same in a content control block for persistence at the consumer node. The content control block is a data structure like or similar to named content delivery data structure 270, but with unencrypted values in the manifest field 280.

In a loop starting at step 339, the consumer node generates a NCRP control packet 201, called an interest packet, to request one or more named chunks of the named content using fields 250b and 250a, respectively. The interest packet includes any user verification fields used to authenticate the consumer at the producer node, as described in more detail in the Example Embodiments Section. In step 341 it is determined if the consumer node is allowed to send the interest packet, based on network response and congestion parameters, using any known method, such as described in more detail in the Example Embodiments Section. If not, then control passes to step 343 to wait based on congestion parameters for retransmission, as described in the Example Embodiments Section in more detail. When the consumer node is allowed to send in step 341 or after waiting in step 343, then control passes to step 345.

In step 345, the interest packet is sent to the IP address returned with the named content delivery data structure, such as the lowest cost proxy or producer. In step 347, it is determined whether a chunk data packet has been received, such as packet 200 with the encoded, and possibly encrypted, chunk data in field 260. If so, in step 349 it is determined if the data is valid using any known technique, such as a hash or checksum, as described in greater detail in the Example Embodiments Section. If valid, then, in step 351, the chunk data is un-encoded, and if encrypted is decrypted, and stored in the local content store for use by the local client. The local content store is a data structure such as depicted in FIG. 2C for holding one or more chunks until those chunks are delivered to the client process at layer 5. In some embodiments, step 351 includes sending the delivered content to the local client application that requested it.

If no chunk data packet is received, or the data is not valid, or after retrieving the chunk data, control passes to step 355. In step 355, it is determined if a chunk is missing, e.g., the most recent chunk is after a chunk not yet received, or if there is any other later chunk still not received, then there is a missing chunk. If so, control passes back to step 339 to generate an interest pack for the missing chunk, as described above.

If there is no missing chunk, then in step 357 the content is passed to the client process on the local node, if not already passed in step 351. Then, in step 359 it is determined whether end conditions are satisfied. If so, then the process ends. Otherwise, control passes back to step 331 and following steps, described above.

FIG. 3C depicts an example method 303 at a content name server (CNS) at module 113 depicted in FIG. 1. In step 361, the CNS receives from a producer a request to register a manifest for named content. For example, when the CNS is on separate node from the producer, data packet 200 is received with the content name in field 250a and the possibly encrypted manifest in field 260. Thus, in some embodiments, step 361 includes receiving, from a first remote node, a manifest registration packet that includes a first reliable protocol payload that indicates a CNS-compatible name for application data and a manifest field, wherein the application data comprises a plurality of chunks, and wherein the manifest field holds data that indicates chunk names and data that indicates encoding of the chunks.

In step 363, the manifest is stored in a named content delivery data structure 270 with the content name in field 272, the manifest in field 280, and a node identifier for the node that sent the registration request in field 289. Thus, step 363 includes storing locally in a named content delivery data structure 270 the CNS-compatible name in a content name field, the manifest field in a manifest field, and a node identifier of the first remote node in an address field.

In step 365, it is determined if a content proxy message is received that indicates the named content, such as a data packet 200 with the content name in field 250a and a manifest or chunk in field 260. This means there is a proxy server in the vicinity that can handle requests for the named content. If so, then in step 367, the node identifier of the message sender is added to the named content delivery data structure 270 record 289. For example, on a modified DNS, the new IP address is added as a DNS type A record. Thus, step 367 includes, in response to receiving, from a second remote node different from the first remote node, a data packet with the CNS-compatible name in a second reliable protocol payload, adding an IP address of the second remote node to the named content delivery data structure 270.

In step 369, it is determined whether a manifest query is received from a consumer. For example, a control packet 201 is received that indicates the named content in field 250a and a field or flag that indicates the control packet is a request for the associated manifest, e.g., in field 250b. If not, control passes to step 379 to determine if end conditions are satisfied. If so, the process ends. Otherwise, control passes back to step 361 and following steps, described above.

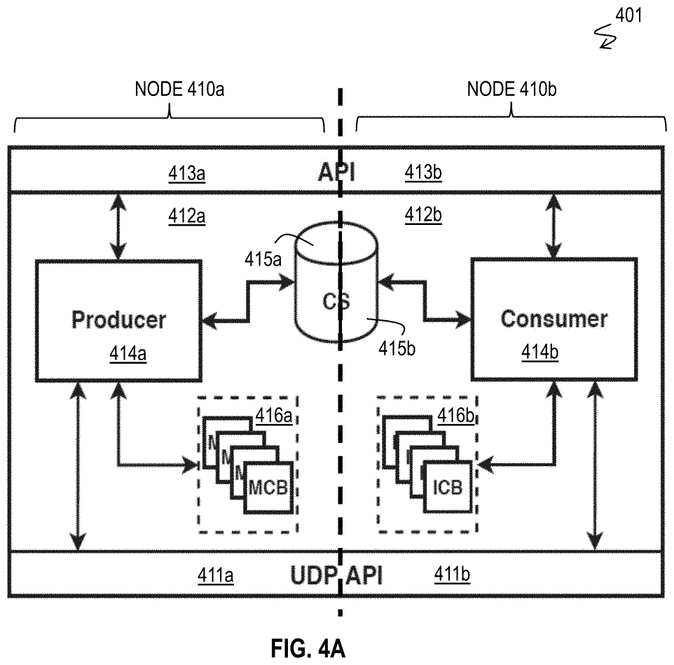

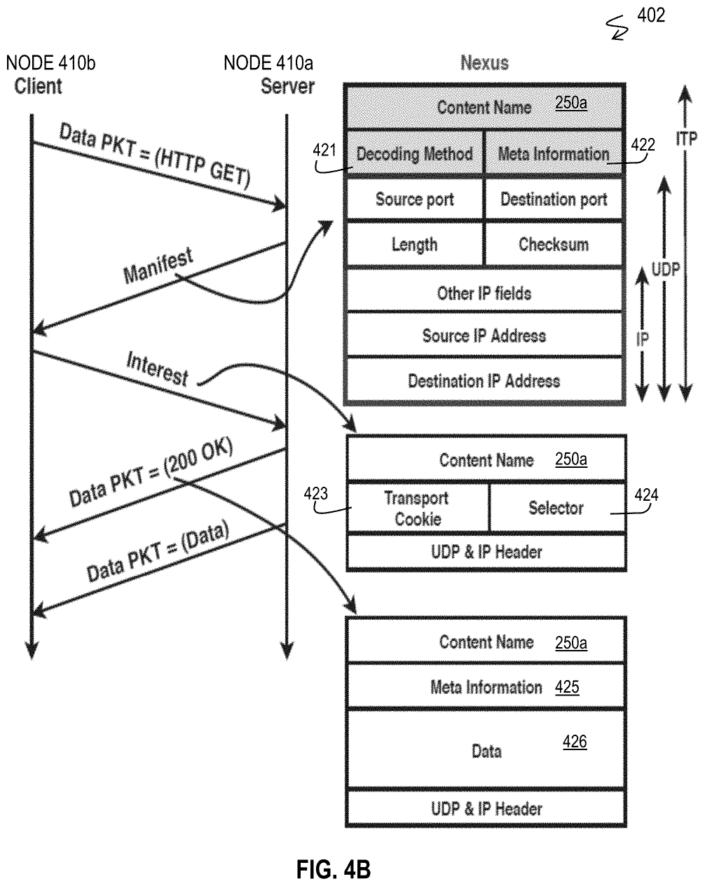

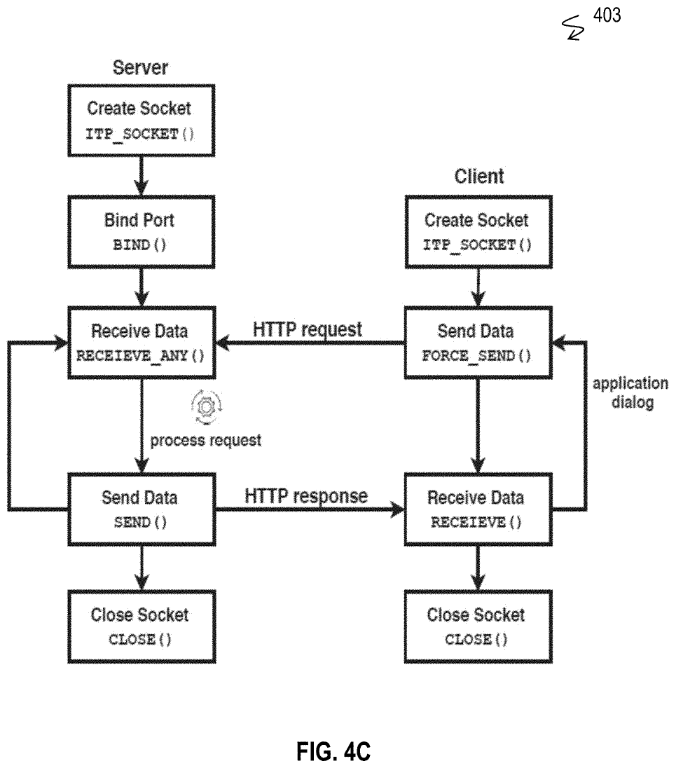

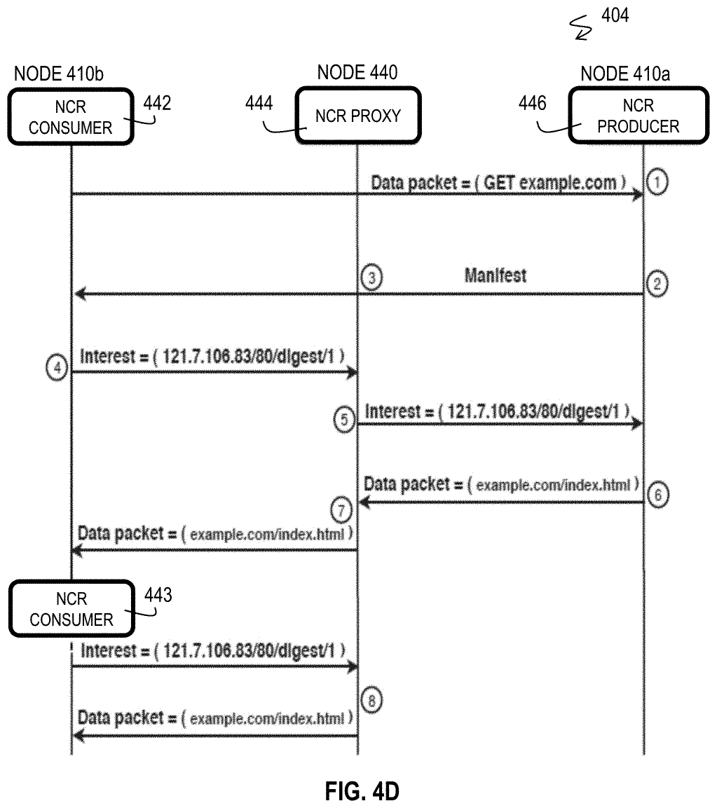

If it is determined in step 369 that a manifest query is received, then control passes to step 371. In some embodiments, there is an authoritative CNS for a particular named content, e.g., at the node where the named content was originally registered. However, in some embodiments, the manifest information can migrate to other CNS nodes that serve as a local CNS. In step 371 and 372, a non-authoritative CNS asks to get a local copy of the manifest to use for subsequent manifest requests, e.g., as depicted in FIG. 4C, described below. In step 371, it is determined whether there is a local named content delivery data structure 270 for the named content. If not, then in step 373 the manifest request is passed to the next CNS. The manifest returned in response is stored locally in a local named content delivery data structure 270.

If the named content delivery data structure 270 is stored locally, then in step 375 the node identifiers in the record are sorted by the cost of transferring data from the node identifier to the consumer node requesting the manifest, using any definition of cost, as descried above. In step 377, the manifest is sent with the node identifier of the lowest cost producer or proxy for the named content. For example, a data packet 200 is sent with the content name in field 250a and the manifest field 280 in field 260. Thus, step 377 includes, in response to receiving, from a third remote node (consumer) different from the first remote node (producer) and the second remote node (proxy), a request for the manifest for the CNS-compatible name in a third reliable protocol payload. This includes sending to the third remote node a data packet that includes in a fourth reliable protocol payload the manifest field and a node identifier for a node that stores the application data. The node identifier is selected from the local named content delivery data structure 270. In some embodiments, the node identifier has a lowest cost among all addresses in the named content delivery data structure 270 for communicating a data packet to the third remote node (consumer). Control then passes to step 379 to check for end conditions as described above.

FIG. 3D depicts an example method 304 at a content proxy node, simply called the proxy hereinafter, as depicted in FIG. 4D, described below. In step 381, the proxy receives from a producer a proxy install message for named content. For example, control packet 201 is received with the content name in field 250a and the chunk names in field 250b. A proxy is a node within network 110 that will copy the encoded and possibly encrypted chunks for faster delivery to consumer nodes distant from the original producer node. The information is stored in a local data structure, such as a data structure identical or similar to named content store data structure 208.

In step 383, it is determined whether a content interest packet is received. If not, control passes to step 393 and following steps, described below to see if a chunk data packet is received. If a chunk data packet is not received either, control passes to step 399 to see if end conditions are satisfied. If so, the process ends. Otherwise, control passes back to step 383.

If it is determined in step 383 that a content interest packet is received, then in step 385 it is determined if the node is proxy for that named content, e.g., that name was received earlier in step 381. If not, control passes to step 391 to forward the content interest packet on to another node on the route to the node identifier specified in the layer 3 header, using normal routing protocols. Control then passes to step 393 and following steps, described below.

However, if the local node is a proxy for this content, then control passes to step 386. In step 386, it is determined whether the chunk with the chunk name in the interest packet is already in the local cache. If the chunk name is encrypted in the interest packet, then step 386 also decrypts the chunk name using a shared key for this purpose. If so, control passes to step 387. In step 387, the encoded and possibly encrypted chunk indicated in the interest packet is retrieved from the local content store and sent to the consumer node in a data packet 200 with the content name in field 250a, the possibly encrypted chunk name in field 250b, and the encoded and possibly encrypted chunk in the field 260. Note that if the chunk is encrypted, then the proxy node does not compromise the application data chunk. Control then passes to step 399 to see if end conditions are satisfied, as described above.

If it is determined in step 386 that the chunk with the chunk named in the interest packet is not in the local cache, then control passes to step 389. In step 389, it is determined if the chunk name is in a local pending interest table (PIT) data structure 251 as depicted in FIG. 2E. The PIT data structure is maintained to hold the names of chunks already requested by the proxy node but not yet received. In some embodiments, the PIT includes the chunk name in field 254 and the names of all consumers requesting the chunk name in interest messages received by the proxy in field 255. If the chunk name is already in the PIT, the consumer field is updated with the latest consumer if different from the already listed consumers. Then the chunk need not be requested and control passes to step 391 to simply pass on the interest packet, as described above. In some embodiments, the interest packet is not forwarded because the chunk has already been requested; and, instead, step 391 is omitted and control passes directly to step 393 and following steps, described below.

If the chunk name is not in the PIT, then the proxy has not yet requested the chunk with this chunk name. Control passes to step 390. In step 390, the chunk name is added to the PIT along with the address of the consumer that sent the interest packet; and, the interest packet is forwarded in step 391, as described above.

If it is determined in step 393, that a chunk data packet is received, e.g., a data packet 200 is received with the content name in field 250a and the possibly encrypted chunk name in field 250b and the encoded and possibly encrypted chunk in field 260, then control passes to step 394. In step 394, it is determined whether the chunk name of the chunk data packet just received is in the PIT. If not, then the chunk is not a chunk of interest to the proxy, or the proxy already received the chunk in a previous data packet; and, control passes to step 397 to forward the data packet to the node identifier of the destination in the layer 3 header.

If the chunk name of the chunk data packet just received is in the PIT, then control passes to step 395. In step 395, the encoded and possibly encrypted chunk is stored in the local cache in association with the chunk name, such as in a local named content store data structure 270; and, the values for that chunk name is removed from the PIT. Control then passes to step 397 to forward the chunk data packet to the all the consumer nodes asking for that chunk, as listed in the PIT. If the chunk packet just received indicates a different consumer node, the chunk packet is also forwarded to that different consumer node.

### 2. Example Embodiments

Example embodiments of NCRP and its relation to TCP, along with relative performance comparisons, are described here.

### 2.1 Content Producer is Also Content Name Server

In example embodiments described in this section, called ITP, the CNS 113 is on the same node 120 as the producer 182; and both processes may be considered one module on that node. Unless otherwise clear from the context, the statements made in this section apply only to the embodiments in this section. ITP overcomes the severe functionality limitations resulting from using TCP connections to maintain the context of associations by using decoding Manifests and transport fields, called transport cookies herein, to maintain the context of associations. A decoding Manifest constitutes a common description of the structure of the content to be shared between a content consumer and a producer. The description frees both producer and consumer processes from having to create and maintain an additional connection structure in real time to ensure that all the portions of the content are received correctly.

The decoding Manifest enables an “asynchronous” type of association between processes that is not lost if physical connectivity is lost. This is called a nexus among the content producer(s), content consumer(s), cache(s), and the components of a content object. Provided that communicating processes can refer to the same decoding Manifest, they can exchange elements of the content described in the Manifest on a transactional basis, and a consumer process is free to contact multiple processes using the same nexus provided by the Manifest. A producer does not have to maintain state for each consumer by having the consumers inform the producer of their status in the nexus using transport cookies in the interest packets. This is similar to the use of cookies at the application layer in order to eliminate the need for servers to maintain a per-client state.

FIG. 4A is a block diagram that illustrates an example architecture for named content delivery, according to an embodiment. There are related modules and data structures on at least two nodes, a producer node 410a (such as node 120 or node 140) and a consumer node 410b (such as node 131 or 132). Of course, on a node that both produces and consumes data, all components are on that one node as well. At each node, modules and data structures in the ITP layer operate between an application layer through its application layer interface (API 413a at the producer node and API 413b at the consumer node), and a conventional UDP layer (through its UDP API 411a at the producer node and API 413b at the consumer node). As FIG. 4A shows, the ITP layer (412a at the producer node 410a and 412b at the consumer node 410b, collectively called ITP layer 412) includes five modules: Producer 414a, Consumer 414b, Manifest control block (MCB) list 416a, Interest control block (ICB) list 416b, and Content Store (415a, 415b, collectively referenced as content store, CS 415). An ITP producer 414a is responsible for sending a content object (CO), such as one chunk, from the CS 415a, and an ITP consumer is responsible for consuming the object, including buffering the CO in a similar consumer CS 415b. The CS 415 is a buffer embodiment of the named content store data structure 208 described above.

The ITP producer needs to remember several variables for each Manifest it creates. The producer remembers these variables in a data structure known as the Manifest Control Block or MCB 416a, which is an embodiment of the named content delivery data structure 270. Some of these variables represent the Manifest itself such as Manifest Timeout and ITP consumers authorized to retrieve its content, in other field 287. All these structures are stored in a list in this embodiment. The MCP 416a is similar to the transmission control block (TCB) used in TCP to maintain data about a connection. However, the MCB is only used to maintain a minimal state about each Manifest constructed while the ITP consumer carries most of the heavy lifting by remembering many variables about the connection and exchange them back with the ITP producer using transport-level fields called transport cookies.

The ITP consumer remembers more variables for each content object to be retrieved. These variables are also stored in a data structure known as Interest Control Block or ICB 416b with fields similar to those in data structure 270. As with the MCB 416a, all these structures are stored in a list in this embodiment. A consumer creates an ICB 416b for each new Manifest it receives. The ICB 416b includes variables such as Manifest name, commensurate with the content name described above, in field 272, list of ITP producers to contact in field 289, Interest timeout and so forth in field 287. Once all the Interest packets (also simply called “Interests” hereinafter) for a content object are satisfied by filling a buffer embodiment 415b of the named content store data structure 208 at the consumer, the ICB triggers the ITP consumer 414b to deliver one or more of the CO from the Content Store to the application.

The Content Store (CS) in ITP resembles the Content Store used in NDN and the send buffer used in TCP; where unacknowledged TCP segments are maintained in case of retransmission timeouts. However, TCP cannot reuse a packet after it has been acknowledged by the other end. While an ITP producer can make use of object chunks (OC) in the CS to satisfy Interests from different consumers, depending on the application need. The CS in ITP is also used to buffer OC's waiting to be requested by an ITP consumer similar to a regular receive buffer in other transport protocols. A content object that is being retrieved is buffered at the CS 415b until all its OC's are received and then it is delivered to the application through API 413b by the ITP consumer 414b. The decision of when to deliver the data to the application is issued by its ICB 416b as mentioned before. The CS stores the OC's based on their name in the Data packet which is specified in the Manifest.

Each data object in ITP carries a name, including the Manifest. The name of the Manifest is mapped to a specification of messages (content) to be sent. A simple approach to name OC's in ITP is by using sequencing with the content name from the Manifest. Using this method an ITP consumer appends a chunk number to the content name of the outgoing Interest and keeps incrementing the chunk name until it receives all the chunks corresponding to the CO. An alternative way to name OC's in ITP is by using a cryptographically secure hash function of their content, similar to the one proposed for NDN [68]. The hash digest for OC's in a Manifest can be thought of as the sequence number in TCP used to identify stream of bytes. This means that a Manifest is a CO with a hash digest as its name that describes an ordered collection of OCs and their corresponding hash digest. The combination of the OC's stated in the Manifest and carried out according to the method indicated in the Manifest renders the original CO. Large COs can be organized into a hierarchy of decoding Manifests, such as hierarchical Manifests proposed in CCNx [26]. To prevent fragmentation and reassembly, an OC should be small enough to fit any link-level frame of a communications packet. To allow transparent caching for data objects in ITP, all data objects names are prefixed with the ITP producer's IP address and application's port number, e.g., /192.100.0.1/80/digest01234567. Using the ITP producer's IP address and application's port number prevents hash collision at the caches. Also, prefixing OCs with the application's IP address and port number allows them to be globally unique.

Reliability is enforced by the ITP consumer side for most of the packets exchanged in a nexus, except for the Manifest, which is enforced by the ITP producer. The ITP producer achieves reliability for the Manifest by keeping a list of authorized ITP consumers to receive a particular Manifest. An ITP producer acknowledges the arrival of a specific Manifest to an ITP consumer by receiving an Interest with a name that maps to the Manifest name. Certain systems call can also enforce the ITP producer to deliver specific Data packets reliably without constructing a Manifest. Such as the one used by the client's application to send the HTTP request. Once the ITP consumer receives a Manifest, the reliability to retrieve the data object is shifted to the consumer side. The ITP consumer keeps a state of unsatisfied Manifests in the list of ICB 416b. A Manifest is satisfied and removed with its ICB from this list, once a consumer issues and satisfies all the Interests related to this Manifest. Once that is done, the consumer invokes the application to deliver the data as explained previously. An Interest is acknowledged by the arrival of a data packet that corresponds to the Interest.

FIG. 4B is a block diagram that illustrates example network traffic 402 using named content reliable protocol (NCR), according to an embodiment. FIG. 4B shows an example of how an association is implemented with a nexus in ITP using a server application on node 410a sending data to a client application on node 410b over ITP. Through a specific system call, the server specifies a number of parameters; the content to send, the IP and port address of the client, and additional control information depending on the system call it used. Rather than setting up a connection to send the data, the ITP process constructs a Manifest and sends it to the client.

As FIG. 4B shows, the Manifest packet includes the content name in field 250a from the values in field 272, which is mapped to a specific buffer that contains the content to be sent out; a decoding method in field packet field 260 portion 421 from the value in field 282 that describes how the client can start retrieving the content residing in the server's buffer, such as the number of chunks to request and the order of chunks 1, and meta information in portion 420 also in packet field 260 based on values in the other fields of manifest record 280. The meta information is used to describe general information about the content such as the chunk's names and size and, in this embodiment, the metadata includes a list of other IP addresses to contact to request the content from field 289 of the named content delivery data structure 270. In various embodiments different fields are included in the meta information or metadata field 284. The other field depicted are parts of the standard UDP and lower layer headers, and so will not be described in more detail here.

The nexus that implements an association in ITP consists of the combination of the Manifest name in field 272 and packet field 250a, the source port number and the source IP address form the standard header fields.

Once the ITP process servicing the client's application obtains the decoding Manifest for the content, it proceeds with a time-window-based sequence of Interests requesting the object chunks that are needed to decode the object as stated in the Manifest. As FIG. 4B shows, each Interest packet includes fields that hold values for the content name in packet field 250a, a transport cookie 423 portion stating the application's IP address and port number, and in a portion of packet field 260 which object chunks (OC's) are still missing and which OC's have been received. This can be viewed as an asynchronous generalization of the type of acknowledgments used in several TCP variants [99]. The ITP process at the server side receiving the Interests answers by sending a sequence of data packets. Each data packet indicates the content name in packet field 250a and in packet field 260 includes meta information 425 and a chunk of data 426. Once the ITP process at the client side retrieves the whole object, it invokes the application process with the retrieved content.

The ITP sender clears the data to be sent out at the buffer depending on the type of nexus. The basic approach is for the ITP receiver to end the nexus unilaterally after receiving all the OC's it needed, and for the ITP sender to end the nexus after a timeout. However, storage may still be an issue at the sender, and it is an option for the ITP sender to request in the Manifest that the ITP receiver should send an Interest with a completion flag to notify the ITP sender that the nexus can clear the data in its buffer.

When the server application sends out its HTTP reply, it is the ITP producer responsibility to construct the Manifest for this data and send it to the ITP consumer at the other end. It is also its responsibility to send requested data packets in response to received Interests. The ITP consumer is responsible for retrieving the data using Interests based on the information provided by the Manifest. The same occurs when the client application sent out the HTTP GET request. However, applications that consume data are naturally different from applications that produce data. Therefore, different system calls are specified to send the data over ITP that fits the application need. For example, when the client sends the HTTP GET request it will be done through a different system call than the one used by the server application to send the HTTP response. This system call triggers the ITP producer at the client side to deliver the Data packet encapsulating the HTTP GET request instead of constructing a Manifest and send it to the ITP consumer at the server end.

FIG. 4C is a block diagram that illustrates example HTTP network traffic 403 using NCR, according to an embodiment. FIG. 4C illustrates, at an application level (layer 5) above the ITP layer, an example of a client/server relationship using the primary socket API functions and methods in ITP. The naming of these system calls is inspired by the early work by Walden on host-host protocols [100]. It can be seen these calls are somewhat similar to the TCP/UDP socket API, but the functions differ significantly. The current TCP/IP socket API dates back to the 1980s with the release of what is called Berkeley sockets. Most of these sockets calls prevent the programmers from understanding what goes on at the transport layer; instead, these calls just produce numeric error codes that usually have a generic meaning. Therefore, the design of ITP API includes providing a platform that simplifies the programming of today's applications while hiding the complexity of the communication calls and allowing application developers to customize their content distribution and have full control over deployment decisions.

As FIG. 4C illustrates, no connection is established from the client to the server like in TCP, and instead, the client just sends messages to the server using the FORCE_SEND( ) call. This is the same system call that was used by the client to send its HTTP GET request in FIG. 4B. This system call will force the ITP consumer at the client-side to send the message directly to the server without constructing a Manifest. Also, the server in ITP does not need to accept a connection, and instead, it just waits for messages to arrive. When a message arrives at the server, it contains the address (IP, Port) of the sender, which then the server can use to reply back to the client through the system call SEND( ). It is up to the application developer to decide if clearing the buffer is done through timeout or by the receiver of the message (client) by passing specific primitives to the system call. ITP is considered to be bi-directional, but it is not fully duplex the same way as in TCP since there is no notion of connection. However, it is up to the application dialog as highlighted in FIG. 4C to handle this. Because sockets by themselves are fully duplexed, an application can simply send back to the port of origin, as mentioned before. Similar to TCP, an ITP server application can close its socket after the dialog ends. However, since there is no notion of a connection between the two ends, a server can only close its socket.

Retransmission and congestion control strategies are adopted in ITP that are very similar to those in TCP. This design takes into account three key differences between ITP and TCP. ITP is receiver-driven, because the use of Manifests to describe a content object allows the ITP consumer to be in charge of controlling retransmissions and managing congestion by adjusting how it makes its requests to the producer. ITP is connection-free by replacing end-to-end connections used in TCP with nexuses whose management is done with a message-switching approach. Lastly, data carried over ITP can be cached transparently at the transport layer, which allows the receiver to obtain the data from multiple sources. The above three features bare similarity with Named Data Networking (NDN) [1].

ITP uses a receiver-driven selective repeat retransmission strategy that takes advantage of the fact that the receiver is in charge of the management of the nexus with the sender. The transport cookie included in each Interest tells the sender what portions of the content have been received and which ones are missing, which serves as a selective acknowledgment used in many TCP variants. The ITP receiver controls the flow of data traffic by controlling the sending rate of its Interests, and allows for a time or packet window to allow data packets to flow to the receiver in response to its Interests. The time or packet window size is adjusted based on the AIMD (Additive Increase Multiplicative Decrease) mechanism commonly used in TCP for the congestion window.

The ITP consumer maintains a congestion window, cwnd, that defines the maximum number of outstanding Interests allowed to send without receiving their data packets. Similar to TCP New Reno, the consumer in ITP increases its cwnd based on slow start, starting with transmitting one Interest and increasing the cwnd by one for each new received Data packet. The slow start continues until a packet loss is detected. In that case the ITP consumer limits the Interest rate by reducing its cwnd accordingly.

The policy used in ITP to retransmit Interests resembles the one used for retransmissions in TCP Santa Cruz [99] the most. ITP retransmits a lost Interest once an out of order data packet is received based on the order in the transmitted list and a time constraint is met. A lost Interest y initially transmitted at time tᵢ is retransmitted once the following constraint is met: As soon as a data packet arrives for any Interest transmitted at tₓ where (tₓ>tᵢ), and (t_{current}−ti)>RTT, where t_{current} is the current time and RTT is the time it takes to send an Interest and receive the Data packet for it. Once ITP detects a packet loss using fast retransmit, the consumer reduces its congestion window by one half and sets the threshold to the new window size causing the consumer to go into congestion avoidance.

ITP does not need to rely on such mechanisms as Fast Recovery in TCP NewReno to detect multiple packet losses within a single window. It is well known that TCP Reno suffers under scenarios with more than one packet loss within a single window.

The congestion-control mechanism in ITP can be used when data are retrieved from multiple sources. When a consumer retrieves OCs for the first time, some of the OCs may be dropped due to congestion. If these chunks are cached on the way before they get dropped then they will be retrieved from the cache instead of the producer for retransmitted Interests. If two consumers with different RTT share the same path to the producer, then some OC's for one of the consumers may be retrieved from the cache instead the producer. Further, as the next section discusses, an ITP producer may obfuscate data by encoding the data with old OCs, and some of these old OCs may be cached and retrieved from caching proxies while other OCs are retrieved from the producer.

ITP uses a single retransmission timeout (RTO) in both single-source and multisource cases along a path. ITP detects when data are being retrieved from a close cache or from the original producer based on the source address of packets. The consumer maintains a list of the sources that are used to satisfy an Interest, only the source with the most satisfied Interests is used as the primary source for the consumer. The consumer only uses the RTT estimate for of the primary source in the RTO estimate. Whenever a new primary source is detected, the consumer resets the RTO estimate based on the RTT values of the new primary source. ITP keeps an RTO for each Interest. When an RTO event is triggered in ITP, the consumer reduces its congestion window to 1.

Transparent caching in the prior art requires caches to be aware they are receiving applications-specific requests transparent to the clients. These caches are required to receive redirected client requests, possibly by intercepting TCP connections destined to particular ports or for a specific set of destination addresses. One example of a widely used transparent caching is transparent web caching, where web traffic is intercepted and redirected toward a web cache server without requiring any configuration at the client. This is usually done by using a layer-four switch on the route between the client and the origin server.

ITP allows application traffic running over ITP to be cached at the transport layer without the caching logic leaking to the application layer. This means that network administrators can simply install a single ITP proxy cache in their network and configure a layer-four switch to redirect ITP traffic to ITP caches. Some embodiments include extending the API for this caching entity to support network features such as load balancing, filtering, or QoS policy for different applications.

FIG. 4D is a block diagram that illustrates example network traffic 404 using named content reliable protocol (NCR) and a NCR proxy at an intermediate node 440, according to an embodiment. The following sequence of ITP Proxy steps for transparent caching of ITP traffic corresponds to the numbers shown in FIG. 4D.

(1) A client sends an HTTP GET request for example.com to a WebServer on node 410a. This request is sent over the system call FORCESEND( ) which causes it to be sent as a Data packet without the need for a Manifest. The ITP Proxy 444, on an intermediate node 440 on the path, is configured to ONLY intercept Interests destined to a list of ITP producers and Data packets from these ITP producers. It is up to the administrator to cache Data packets sent by the client applications to these webservers but there is no meaning for it.

(2) After the ITP producer 446 at the webserver processes the incoming data packet it will deliver it to the webserver application along with the client IP address and Port number. Once the application processes the message it will trigger a reply back to the client with the proper HTTP response using the system call SEND( ). This causes the ITP producer 446 to construct a Manifest and send it to the ITP consumer 442 at the client side.

(3) A layer-four switch intercepts the packet from the web server and redirects it to the ITP Proxy 444, which continues to forward to the client on node 410b where it is processed by consumer 442. (4) After processing the Manifest, the ITP consumer 442 sends an Interest to the ITP producer 446 at the other end.

(5) The ITP Proxy 444 on the way intercepts the Interest then checks if it has the requested Data packet in its content store. Since it does not, it forwards it to the ITP producer 446 using the Interest name. (6) After processing the Interest, the ITP producer 446 responds with the requested data packet.

(7) The ITP Proxy 444 intercepts the Data packet and caches it in its Content Store if it does not exist to satisfy incoming future Interests. It then forwards it to the ITP consumer 442, which after processing it, will deliver it to the application layer. (8) Finally, the Interests from a new ITP consumer, e.g., 443 (who has the same Manifest) will be satisfied by the ITP Proxy 444 instead of going all the way to the ITP producer 446.

As illustrated in the example, ITP caches do not need to keep track of pending Interests as it is done in NDN. In addition, current caches rely on the application in order to specify the server, by using fields like complete URL as in HTTP. In ITP, every Interest is an atomic operation. When an ITP cache at proxy 444 cannot satisfy an Interest, the proxy 444 simply forwards the Interest to the ITP producer 446 based on the Interest name specified by the Manifest. As a result, forwarding Interests to the original ITP producer 446 will simply rely on datagram routing in the Internet and, advantageously, does not require any change to the routing infrastructure, which IS required in NDN.

Another advantage in some embodiments is to provide confidential and authenticated communication while also leveraging caching to enable scalable, multi-party communication. An alternative would be to use group keys, where the producer 446 encrypts each content object with a unique key known as a group key. Only authorized consumers are given access to this key; thereby allowing content objects to be transparently cached without compromising the privacy of a client or the producer. Once consumers authenticate themselves using a PKI for example, they can obtain the decryption key.

There are many simple ways in which cached content objects (CO) can be obfuscated from the standpoint of caching sites and routers. For example, multiple original COs can be combined in the same coded fragments, the level of obfuscation obtained by the coded data in the absence of a decoding Manifest is sufficient to store coded data in caching sites with no need for encryption while providing a fair amount of privacy to end-users. The trade-off with obfuscation is that more coded fragments that combine the original COs are needed to decode. Another approach is to combine a CO with “useless” data intended solely for obfuscation to produce a set of coded fragments.

An example of data obfuscation that could be used in ITP to provide privacy is based on combining a CO with already cached COs at the Content Store for obfuscation. This produces a set of coded fragments that is unique for every consumer. This approach does not provide complete confidentiality, but it increases the complexity snoopers to decode cached COs without their Manifest. For example, for every CO sent by the producer, ITP will generate a new Manifest based on previous work [89], which is mainly used for censorship at storage systems.

To reduce the cost of security and leverage the level of privacy, one OC only is advantageously retrieved using PKI encryption as part of the Manifest. In this way, even the exact data within the caches is useless without this OC. In addition, one way to ensure privacy among consumers retrieving the same Content Object is to obfuscate a subset of OCs in a different way for each consumer. For some embodiments, all chunks objects in ITP are of the same size, so compatibility will not be an issue when generating a random combination of coded chunks. Also, in case the content store is empty, ITP generates a random set of blocks and cache them in the content store during start time. To allow privacy among consumers of the same content objects, in some embodiments, a producer can simply generate random object chunks for a specific set of chunks for each consumer.

To truly protect cached content using a decoding Manifest, only authorized consumers should be able to obtain the decoding Manifest without caches, routers, and unauthorized consumers being able to receive it as well. One way to do this in ITP is to use PKI to deliver the Manifest to authorized consumers securely. This means that a cache has no way of knowing which object chunk (OC) to use to decode the original CO, even though a cache will have access to all OCs transmitted in the network.

One way to ensure the integrity for every packet between both the consumer and the producer is to use a digital signature similar to what is done in NDN. The signature for these packets can be generated using a PKI algorithm. As mentioned earlier, verifying the Manifest using the public key cryptography allows consumers a faster verification of OCs listed in the Manifest. This is because only a simple computation is required of OCs digest and comparison to the digest specified in already verified Manifest.

Here is evaluate the performance of ITP, TCP and NDN using the ns3 [91] and ndnSIM [1] simulators, and consider the efficacy of congestion control methods, the efficiency of transparent caching, fairness, and TCP friendliness.

First compared was the congestion control algorithm and retransmission policies of ITP, TCP and NDN. A scenario was considered of a simple network consisting of a single source and a single sink. It is assumed that NDN uses an end-to-end protocol that behaves in the same way as TCP to provide a fair comparison. Accordingly, consumers in NDN can only infer congestion via a retransmission timeout and use AIMD window control to avoid congestion. Such a mechanism is used by most end-to-end protocols in ICN. The topology of the network is a single path of four nodes with a single sink at one end and a server at the other end. Both ends share a common bottleneck of 1.5 Mbps. For a fair comparison, no in-network caching for ITP takes place in this scenario. The size of the object chunks in ITP and NDN are equal to the segment size in TCP, and fixed at 1500 bytes (B). Both ITP and TCP share the same fixed header size, and a shorter content name is used in NDN to avoid additional overhead in NDN due to large names.

The evolution of the congestion window is determined for three protocols during the first 30 seconds (s) of downloading a file of 3.7 megabytes (MB). The growth of the congestion windows for all three protocols matches the expected behavior of the AIMD algorithm. However, a consumer in NDN cannot detect the data source, which prevents the use of out-of-order delivery methods to detect packet losses. Accordingly, consumers must rely on methods that depend on retransmission timeouts [5, 16]. This degrades the overall completion time for NDN compared to TCP and ITP as Table 1 shows.

TABLE 1
Single flow comparisons showing
superior performance by ITP.

| | ITP | TCP | NDN |
|---|---|---|---|
| Total time (sec) | 33.2694 | 35.5447 | 35.9408 |
| Average throughput | 1.41298 | 1.34652 | 1.2736 |
| (Mbps) | | | |
| Packet loss | 39 | 59 | 56 |
| Jitter sum (sec) | 3.3151 | 4.2827 | 4.9951 |

ITP detects and recovers from a packet loss faster than TCP because of its retransmission policy. As Table 1 shows, the completion time for TCP is higher than in ITP. This is mainly due to ITP not using connections and applying a fast retransmission strategy enabled by Manifests. It takes TCP a minimum of 1 RTT to start sending data while it takes, ITP only half the RTT. In addition, when TCP closes a connection, both ends must terminate the connection even if only one of the ends was transmitting data. However, for ITP, only the consumer signals the producer that the complete data was received. In addition, multiple packets lost within a single window can affect TCP performance even with the SACK option enabled. Because ITP is receiver driven, the consumer has a complete picture of which Data packets were received correctly and which, if any, was lost. ITP does not rely on partial ACK's like TCP does. Accordingly, ITP more immediately goes into congestion avoidance state, instead of fast recovery. As a result, ITP continues increasing its congestion window normally. This gives ITP the advantage of utilizing the bottleneck's buffer compared to TCP, especially under shallow-buffer scenarios [2]. Both NDN and TCP have more extended idle periods compared to ITP. As a result, ITP achieved higher average throughput due to better utilization of the link's capacity and the buffer size, as shown in Table 1.

The total time taken to retrieve multiple copies of a large data file was compared using ITP, TCP, and NDN. The experiment assumes a network consisting of a source node connected over a 10 Mbps shared link to a cluster of 10 sink nodes, all interconnected via 100 Mbps links, where an intermediate node in this scenario is acting as a caching proxy for ITP traffic. The same topology was used for NDN as well. For a fair comparison between NDN and the other protocols, the same transport protocol highlighted in the previous scenario was used. Ten scenarios were run. With each scenario, the number of sinks in the network was increased, bringing the total to 10 sinks. Each sink starts pulling a 6 MB data file from the source at random start time based on a Poisson distribution with an average arrival of 5 minutes. Each scenario was run ten times, each one with a different random arrival time.

The total elapsed time for all the sinks to complete the task was recorded. With only a single sink, all of TCP, ITP, and NDN perform the same, given that most of ITP and NDN requests were retrieved from the source, and all three approaches use a similar algorithm for congestion control. As the number of sinks increases, the completion time in ITP and NDN remain fairly constant for all ten scenarios, while the completion time in TCP increases linearly because all the data have to be retrieved from the source. NDN outperforms ITP when two or more downloads start before data are available at the nearby cache. In ITP this results in those Interests being sent to the producer while in NDN only the first Interest is sent. This scenario highlights the ability of ITP to take advantage of transparent caching without requiring any changes to the communication infrastructure.

ITP fairness was evaluated under a multiple-flow scenario. The topology consists of two consumers and two producers connected via a bottleneck link with 1 Mbps capacity. The queue size is set to 20 packets and the file size is 10 MB. Both producers transmit the Manifests for the file at the beginning of the simulation at the same time. Both consumers start issuing Interests to retrieve the data from the producer after receiving the Manifests. Jain's fairness index F was used as a performance metric for this scenario, which is defined by Equation 1.

$$F = \frac{{( {\sum }_{i = 1}^{n} {x}_{i} )}^{2}}{n {\sum }_{i = 1}^{n} {x}_{i}^{2}} \qquad ( 1 )$$

where xᵢ is the throughput for the ith connection, and n is the number of users sharing the same bottleneck resource. The fairness index F is bounded between 1/N and 1, where 1 corresponds to the case in which all N flows have a fair allocation of the bandwidth (best case), and 1/N refers to the case in which all the bandwidth is given to only one user (worst case).

The evolution of cwnd for both consumers follows the usual TCP sawtooth behavior since both are based on AIMD congestion control algorithm. The fairness between the two flows is F=0.99, because both consumers achieve a similar average throughput.

The case of multiple ITP flows under different initial start times was also evaluated. Consumer 1 starts requesting the data at the beginning of the simulation, and once it fully utilizes the link capacity, consumer 2 joins the network and starts sending Interests to its associated producer at the other end. This is approximately 10 seconds after the beginning of the simulation. Once consumer 2 joins the network, it causes a buffer overflow, which results in a packet loss for both consumers, who each decrease its sending rate by halving their congestion window and then going into congestion avoidance. Both consumers achieve a similar sending rate until consumer 1 leaves the network, and consumer 2 utilizes the remaining link capacity.

To examine TCP friendliness in ITP, two scenario were considered: one in which caching takes place and one without caching. The topology of the network consists of a bottleneck link of capacity 1 Mbps and a buffer size of 20 packets. For the sake of simplicity, the chunk size of ITP is fixed at 1000 bytes, and the same goes for the segment size of TCP. TCP operates with the SACK option enabled, and ACK's are not delayed. Both TCP and ITP have the same round-trip-time delay, and they are retrieving the same file of around 3 MB insize. For the scenario with cashing, ITP caching proxies are configured in the topology before the bottleneck. This allows the ITP caching proxy to serve the consumer's Interests for dropped Data packets due to congestion along the bottleneck. Initially, the ITP caching proxy is empty and caches any data packets that pass through it. A router is configured to interrupt ITP packets based on the protocol number and redirect them to the ITP caching proxy.

Without caching, using Jain's fairness index, the fairness between the two flows is F=0.9988, which is understandable since ITP also follows an AIMD congestion control algorithm like TCP. The same goes for the scenario where caching takes place. The results illustrate that caching does not cause a high decrease in fairness; in fact, fairness between the two flows was F=0.9967. This is due to the ability of ITP to detect that most packets were retrieved from the primary source, and therefore control its sending rate accordingly. Even though ITP achieved less fairness than two competing TCP flows under the same scenario (where F=0.999996), the total download time for TCP flows retrieving the same file size as TCP and ITP was higher by 8.5%. Thus ITP is the first connection-free reliable protocol. Its design consists of the integration of a message-switching approach first discussed by Walden [100, 101] with the use of Manifests, receiver-driven Interests [55], and transport-level cookies. ITP eliminates the need for servers to maintain per-client state and allows for all application data to be cached on the way to consumers using ITP Caching Proxies that can act as middle boxes. To prevent the middle boxes from accessing cached content, ITP relies on decoding the data in a way that can only be understood by a consumer that has the Manifest for this particular data.

### 2.2 Content Producer Uses Separate Content Name Server

In this embodiment, the NCRP consumer and proxy may be the same as described above. However, in this embodiment a domain name server (DNS) is commandeered to double as a content named server (CNS) for the NCRP. To distinguish this embodiment from the more generic embodiments described in the earlier sections, this embodiment is called Named Data Transport, NDT, for a NDT protocol (NDTP).

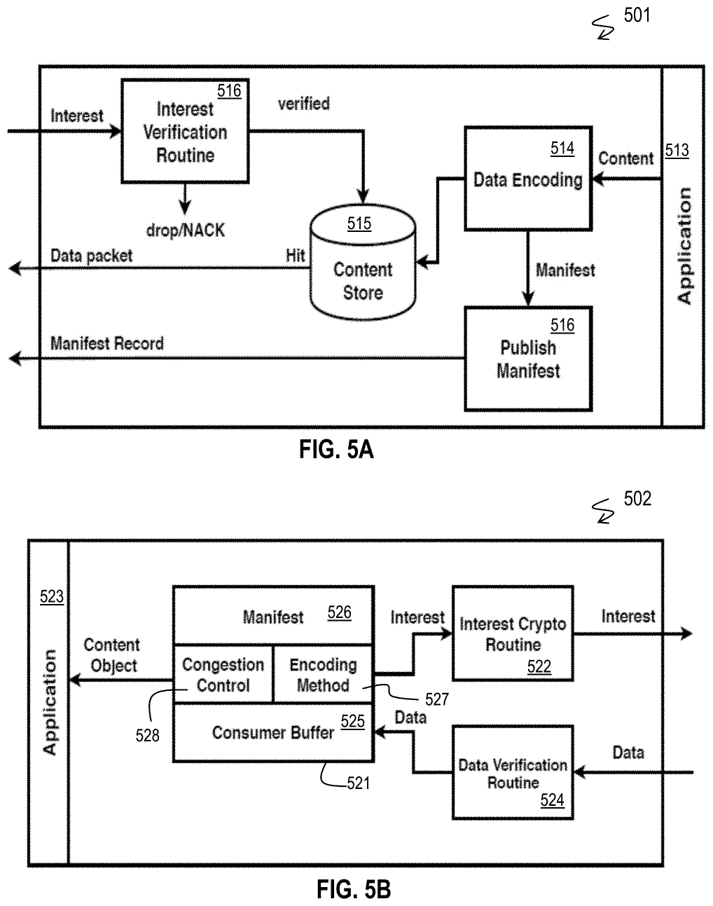

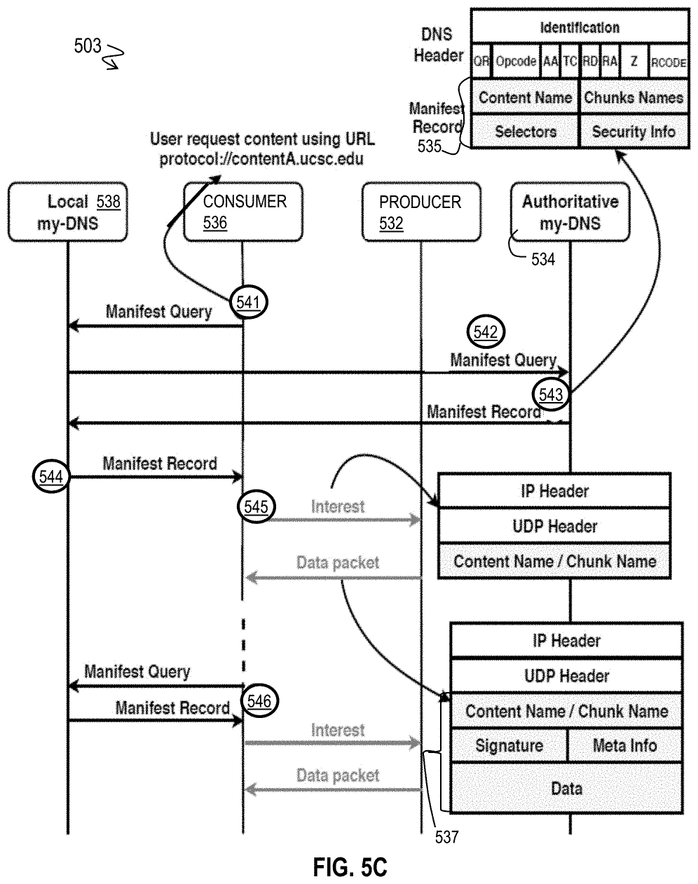

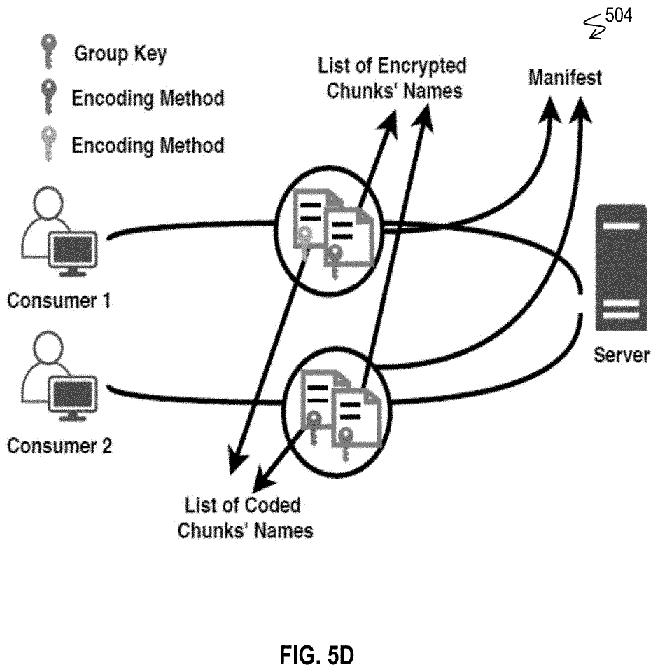

FIG. 5A is a block diagram that illustrates an example architecture for a named content producer 501 using a separate name server, according to an embodiment. Various functions of the producer process (e.g., 182 or 184), depicted as method 301 in FIG. 3A, are depicted in FIG. 5A as separate boxes. When a server application 513 needs to publish content, it is the responsibility of the NDTP producer 501 to publish the content on the Internet. This consists of three main parts: (1) saving the content object and its name into its content store 515, (2) sending requested data packets in response to received Interests at an interest verification routine 516, and (3) using publish manifest routine 516 to publish a manifest record for the content object by registering it along with its name at its authoritative modified DNS server called a manifest yield DNS server (my-DNS). Fields in any or all of the content store 515, and manifest, and data packet may be encrypted.

Before publishing content on the Internet, the producer 501 segments the content into multiple chunks and encodes them into a specific way to ensure the privacy of cached content. Chunks can also be signed and encrypted to ensure security at this stage. Once the content is segmented into multiple chunks, it is cached at the content store 515. The content store 515 can be viewed as the sender buffer in TCP and other connection-based transport protocols. The producer 501 then appends the names of the chunks into the manifest along with the encoding method and other security parameters. The final stage of publishing content on the Internet is by publishing its manifest. This is done by constructing the manifest record 280 using the manifest itself, e.g., fields 282, 285, 286 and meta-information about the content (e.g., a time to live in field 287, list of servers to contact in field 289, etc.—as stated above, what fields are included in or outside of metadata field 284 may be different in different embodiments.) The producer 501 then registers the manifest record along with the content name in field 272 with a my-DNS authoritative server as CNS 113 on node 112. Registering and updating manifest records can be done using regular DNS standards [92], and it is up to the content provider to determine which sites to use to host content objects.

An Interest from a consumer goes through the Interest verification routine 516, which is used to authenticate it. The Interest is simply dropped if the verification fails, and a data packet is sent back if it succeeds. A null acknowledgement message (NACK) can be sent back to the consumer if desired. The design of NDTP allows application developers to customize their content distribution and have full control over deployment decisions.

FIG. 5B is a block diagram that illustrates an example architecture for a named content consumer 502 using a separate name server, according to an embodiment. Of course, a node that acts as both a producer and a consumer include the components of both FIG. 5A and FIG. 5B. In this diagram, both processes and data structures are represented by boxes, and process boxes can be conceptualized as representing the process modules as data structures that indicate the instructions for the process. Various functions of the consumer process (e.g., 183), depicted as method 302 in FIG. 3B, are depicted in FIG. 5B as separate boxes in consumer 502.

Client applications 523 running over NDTP retrieve data objects using their name (URL). The client 523 only needs to provide the content object name to the NDTP layer consumer 502, and the NDTP consumer 502 does all the work in retrieving the content, which involves contacting the local my-DNS to retrieve the manifest record, and requesting the actual content and decoding it. Using the NDTP API, clients 523 access the content directly through the function GetContentByName( ), which takes the content name as its parameter. Calling this function invokes the consumer 502 of the NDTP layer.

The NDTP consumer responsibility can be broken into two main tasks: resolving content names to their manifest record, and retrieving the content using information from the manifest record. As FIG. 5B shows, the consumer in NDTP remembers a set of variables for each content that needs to be retrieved. These variables are stored in a data structure called the Content Control Block or CCB 521, which is used to control such things as Interest timeouts, window size, and the decoding method. All Interests go through the Interest crypto routine 522. The routine signs these Interests based on information from the manifest. Arriving data packets including manifest packets go through the Data verification routine 524 for authentication as well as checking if packets are corrupted. So decoded chunks are in consumer buffer 525 of CCB 521. The buffer 525 may be structured as the content store data structure 208 for one or more chunk records 290 until those records are successfully transferred to the client 523. The encoding method 527 is stored in the CCB from field 282 of the manifest record 280 passed in field 260 of NDTP manifest packet. Other fields of the manifest record 280 or the transport data structure 270 are stored by the consumer in local manifest cache 526. Parameters for congestion control process, or the process itself. is represented by a congestion control module 528 also in CCB 521 in the illustrated embodiment.

Retransmission and congestion control at the consumer are as described above for ITP. Proxy servers and securing proxy cached content may also behave as described for ITP.

NDTP uses a manifest yielding DNS (myDNS) as a separate CNS. NDT attains location-independent content naming through the integration of name resolution with the reliable protocol used to carry content reliably. A new resource record type, which NDT calls manifest record is added to the DNS, resulting in the manifest-yielding DNS (my-DNS). Instead of creating a new type of DNS resource record for the manifests, it is possible to encode the manifest using a TXT record instead. A manifest record may be configured as depicted in FIG. 2D and describes the content structure by carrying the manifest generated by the NDTP producer, lists in field 289 the IP addresses of the different locations of the content on the Internet, and other information, such as other fields 287 specifying the freshness of the content and encoding methods field 282 specifying security parameters.

Content naming in NDT is inspired by the iDNS approach [84] to separate the content name from its location on the Internet. Content names in NDT are based on DNS domain names, allowing them to be persistent and unique through the hierarchical nature of my-DNS. For example, the content name contentA.ucsc.edu represents contentA hosted by the DNS domain ucsc.edu. With NDTP help, each content name on the Internet is mapped to an individual manifest generated by its producer 501, as explained in the previous section. Having a single authority on manifests allows consumers to authenticate the origin of content on the Internet easily and ensure uniqueness of names. To achieve a near-replica routing of content, my-DNS is used to map the name of a content object to the manifest record that describes the locations and structure of the content object to the consumers on the Internet. In turn, a manifest record maps the manifest of a content object to a field 289 holding a list of IP addresses hosting a replica of the content. Each one of these addresses is added to the list as an individual DNS type A record. The my-DNS updates this list as appropriate. This includes sorting the list by the nearest replica based on the consumer's geographical location issuing the DNS query for the content name. Such an approach is already being used to enhance domain-name lookup on the Internet by many vendors. Because NDT uses standard DNS procedures to resolve content names to manifest records, it can also rely on standard DNS procedures to dynamically register content names with its corresponding manifest records. This is similar to the case in which a website adds DNS records to its authoritative DNS server. Content servers can dynamically register the content name with their manifest record using dynamic update DNS mechanisms [92].

FIG. 5C is a block diagram that illustrates example network traffic 503 using a separate name server, according to an embodiment. FIG. 5C shows the steps used in NDT to resolve a content name into a manifest record using my-DNS. Four processes are shown on four different network nodes, including: an NDTP producer 523, an authoritative my-DNS 534, an NDTP consumer 536, and a local m-DNS 538 that can provide a proxy manifest. After the NDTP producer 532 has registered a manifest record 535 with the Authoritative my-DNS 534, the Authoritative my-DNS 534 has a local cache that includes a manifest record 535 as a type A text record following a conventional DNS header. The manifest record 535 includes the unencrypted content name, the encrypted chunk names, selectors and security information in various fields. In Step 541, an NDTP consumer 536 issues a manifest query with the content name to the local my-DNS 538. The manifest query is merely a DNS query with the name field (QNAME) set as the content name and the type field (QTYP) set as a manifest record type, in addition to the standard DNS message fields. Assuming that a specific my-DNS zone manages the manifest records under its zone, the local my-DNS 539 queries iteratively the global my-DNS for the location of the authoritative my-DNS 534 of the my-DNS zone specified in the URL. After the local my-DNS 538 obtains the IP address of the authoritative my-DNS 534, it sends a query of a manifest record type along with the content name, as shown in Step 542. In response to the query from the local my-DNS 538, the authoritative my-DNS 534 returns the manifest record associated with this content name, as shown in Step 543. In step 544, the local my-DNS 538 forwards the manifest record to the NDTP consumer 536. After receiving the manifest record from the local my-DNS server 538, the NDTP consumer 536 can start issuing Interests to retrieve the content, as shown in Step 545. The returned data packet includes the content name in packet field 250a, and the rest of the chunk data such as chunk name, signature, met information and the data chunk itself in packet field 260 shown in FIG. 5C as named data record 537. When another NDTP consumer tries to retrieve the same content, the local my-DNS 538 simply returns the manifest record that has been cached, as shown in Step 546.

NDT ensures the security of the content itself, rather than relying on closed private connections. To protect the authenticity and integrity of the content objects, the manifest record is advantageously secured. This could be done by relying on digital signatures based on public-key cryptography as in DNSSEC [30]. However, DNSSEC is not widely deployed, is expensive to operate, and is not viewed as a complete solution [6]. New techniques are clearly useful to secure and protect manifest records.

Without proper care, adding manifest records to the DNS could lead to scaling problems resulting from IP address changes for content servers and mirroring sites hosting large numbers of content objects, each with a manifest record that must be stored. Fortunately, adding a layer of indirection prevents this problem, and the DNS design already provides the means to add indirection via the CNAME resource records. Using the CNAME records instead of the type A records of the content producer inside the manifest records, DNS updates messages to the producer are avoided. Whenever a content producer changes its IP address, only the type A record stated in the CNAME record of the content producer needs to be updated. To ensure consumers keep up with the changes of the IP address of the content server, the TTL can be set low for these records. This action does not increase the load on the authoritative DNS 534, as has been discussed in the past in the context of mobile networks [95]. In addition, notification mechanisms can be used to update the local DNS 538 with the new IP address proactively using known consistency mechanisms proposed for the DNS [23].

Mapping a domain name for every content object incurs an increase of several orders of magnitude in the storage capacity needed in the authoritative DNS 534 and local DNS 538. This may appear too onerous at first glance; however, as has been noted before [84], most of today's HTTP servers can handle such a load (by hosting an entire directory tree), and a dedicated DNS can be used to host and manage manifest records for content objects under a separate domain. For example, the DNS resolution for the hierarchical content name fiContentA.Contents.example.comfi would consist of four requests; the first one to the root server, the second one to the TLD server for com, the third one to the authoritative server for example, and the final one to the authoritative DNS 534 for the content, e.g., Acontent.

In terms of the size of the manifest records that are handled by the DNS, RFC 1035 [66] already defines mechanisms on how to handle large DNS responses. This is done by relying on TCP instead of UDP to handle such a response. However, another approach is to use a layer of indirection by having a manifest record pointing to other manifests that can be retrieved from the content producer responsible for publishing the content objects and its manifest record instead of using the authoritative DNS server.

From a security of standpoint, content carried over NDTP can be public or private. Protecting the privacy of public content is not a concern; however, authentication and integrity is advantageous. By ensuring the integrity and authenticity of the manifest record using methods like DNSSEC [30], as explained previously, allows NDTP to ensure the security of the content as well. Part of a manifest record is the name of the chunks that are requested using Interests in order to construct the content object. By using a hashing function, NDTP uses each chunk hash digest as the name. As a result, the manifest contains the content name, the digest of each chunk composing the content, and the hashing function used by the server to name these chunks, similar to the one proposed for NDN[68]. Further, by computing the hash digest of these chunks, an NDTP consumer can verify the authenticity and integrity of a received data packet.

NDTP relies on multiple security methods to ensure the protection of private content. The goal is to ensure privacy while also enabling transparent caching of content. To achieve this, NDTP advantageously ensures the following: (a) Only the NDTP producer and the NDTP consumer of a content object should be able to access the content object to preserve privacy, (b) NDTP producers and NDTP consumers should be able to authenticate each other, (c) NDTP consumers should be able to detect the integrity of received content objects, and (d) NDTP should at least provide the same level of anonymity as HTTPS.

In some embodiments, the return manifest is simply a list of tuples, each describing what chunks to request and how to decode the original chunk. After receiving its manifest, the NDTP consumer simply sends Interest for the coded chunks corresponding to the original chunk in the manifest.

Data encoding alone is not sufficient to provide complete confidentiality, but it could be enforced by using group keys to partially encrypt some of the coded chunks. FIG. 5D is a block diagram that illustrates example network traffic using partial encryption for proxy servers, according to an embodiment. FIG. 5D shows a high-level view of the NDTP encryption operation. In the example, two consumers retrieving the same content have two different encoding methods but only one group key. Having a group key ensures that caches are not able to decrypt cached chunks. The group key also allows for overlapping requests to benefit from transparent caching.

To increase the level of obfuscation, the producer can apply an all-or-nothing transform, where caches or consumers in the same content list cannot decode the content unless all chunks are known. The trade-off with obfuscation and using group keys is that more coded chunks that combine the original content are used to decode it. However, the older the chunks used to obfuscate the content, the higher the chance that it will be retrieved from a closed cache. Also, this method can be used to populate caches with chunks from other content objects.

To provide partial encryption while also leveraging caching, only the manifest is secured using public key encryption. By using a specific URL format, an NDTP consumer knows that its request is for private content (like in HTTPS). In this case, there is no need to query the DNS server for the manifest record of the content. Instead, the consumer sends its request to the IP address of the content provider, just as in HTTPS. However, the NDTP consumer can still rely on the DNS to retrieve the necessary keys of the NDTP producer. This can be done by using techniques like DNS-based Authentication of Named Entities (DANE) [53], which allows the publication of Transport Layer Security (TLS) keys in zones for applications to use. After the NDTP consumer retrieves the IP address and the server key, it can issue a Manifest Interest encrypted using both the client and the server public and private key to ensure its authentication, integrity, and encryption. Once the server proves the client is authorized to request the content, it will then send back the manifest. While this is happening, NDTP caches on the way will not be able to intercept and understand either the Manifest Interest or the manifest itself since they are encrypted. To allow transparent caching while also ensuring privacy, the manifest contains a specific encoding method that is unique for each consumer and a group key that is unique for each content as explained earlier.

The performance of NDT, TCP, and NDN was compared using an NDT implementation in ns-3 [91] and off-the-shelf implementations of TCP, DNS, and NDN in ns-3 and ndnSIM [1]. The ns-3 implementation of NDT is publicly available to the research community [4] to facilitate reproducibility of results and future NDT improvements.

This experiment highlights the inherent benefits of using a receiver-driven connection-free reliable protocol over a connection-based transport protocol using similar retransmission and congestion control mechanisms. The congestion-control and retransmission mechanisms of NDTP and TCP were compared assuming a scenario consisting of a simple network with a single source and a single sink. The topology of the network is a single path of four nodes with a single consumer/client at one end and a producer/server at the other end. Both ends share a common bottleneck of 1.5 Mbps and no in-network caching takes place. The propagation delay between the two ends is set to 40 ms. The consumer in NDTP issues Interests for the content served at the other end after requesting the manifest for this content from the producer. The client in TCP consumes traffic generated by the server after establishing a connection with it using the TCP three-way handshake. The size of the object chunks in NDTP is equal to the segment size in TCP, and fixed at 1500 bytes. Both NDTP and TCP share the same fixed-header size.

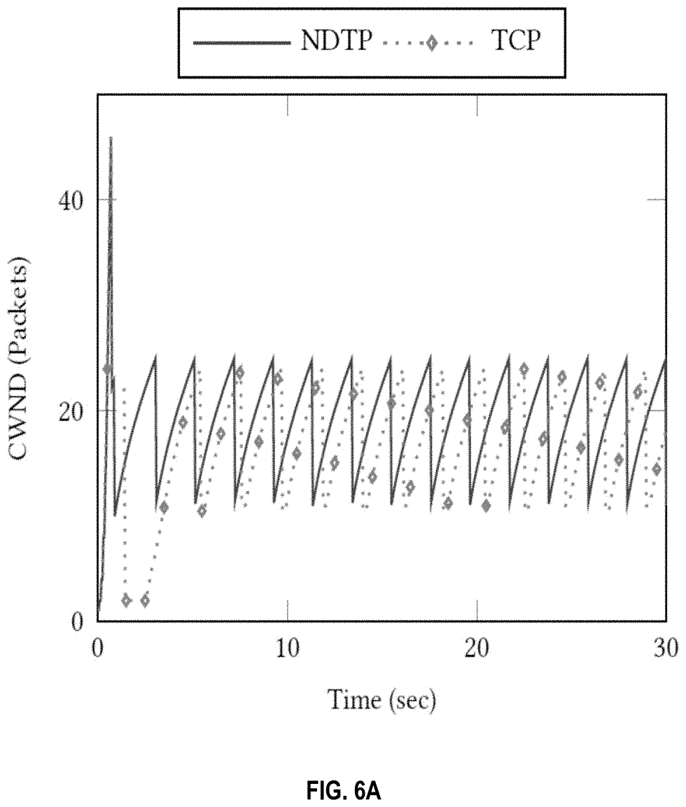

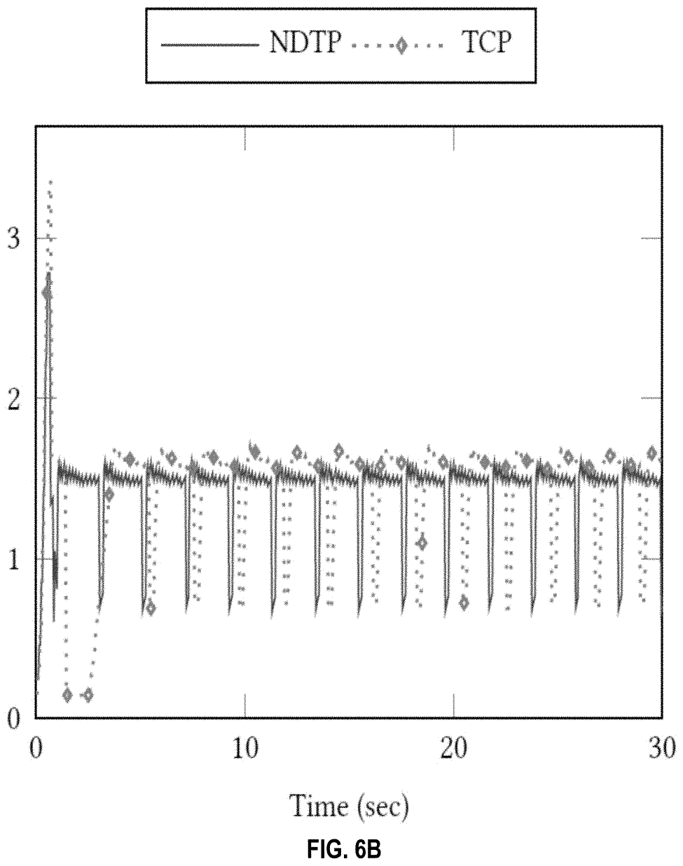

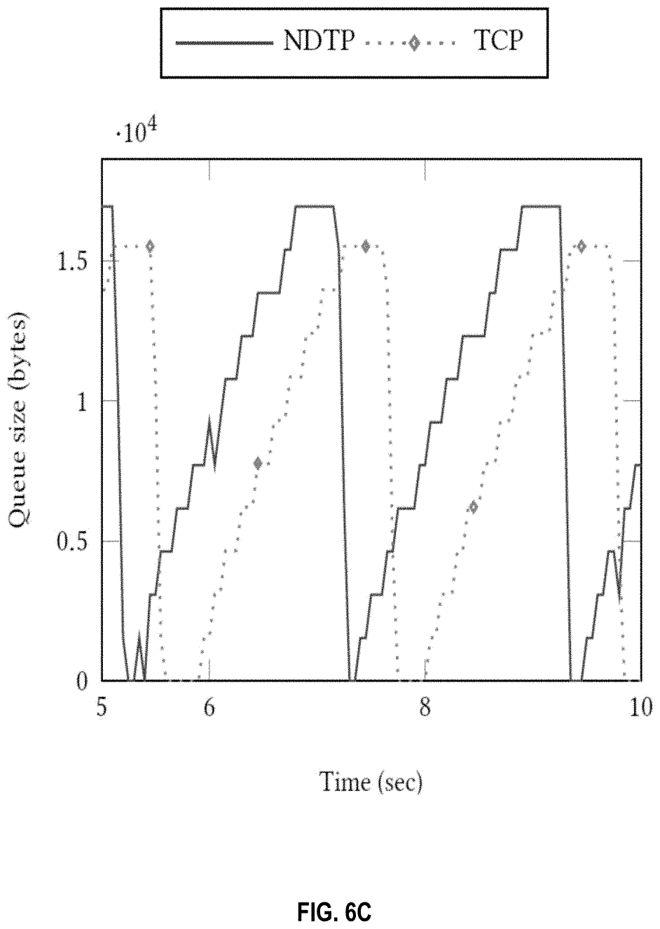

FIG. 6A through FIG. 6C are plots that illustrate example performance using named content reliable protocol (NCRP) compared to TCP, according to an embodiment. FIG. 6A shows the evolution of the congestion window, cwnd, on the vertical axis for both protocols during the first 30 s on the horizontal axis of downloading a content of 3.69 megabytes (MB), a total of 2465 chunks/segments. The growth of the congestion windows for both protocols matches the expected behavior of the additive-increase multiplicative-decrease (AIMD) algorithm. FIG. 6B shows the evolution of throughput in megabits per second (Mbps) on the vertical axis, for both protocols during the first 30 s on the horizontal axis, while downloading a content of 3.69 megabytes (MB), a total of 2465 chunks/segments.

The retransmission policy in NDTP allows receivers to detect and recover from a packet loss faster than in TCP, where it took the client a total of 35.5 s to download the file compared to the total download time of 33.2 s in NDTP. This difference is mainly due to the fact that NDTP does not use connections and applies a fast retransmission strategy enabled by manifests. A consumer in NDTP has a complete picture of which OCs were received correctly and which were lost, and does not rely on partial ACKs like TCP does. Accordingly, the consumer immediately goes into congestion avoidance state, instead of fast recovery. As a result, NDTP continues increasing its congestion window normally. This allows NDTP to use the bottleneck's buffer more efficiently compared to TCP, which is forced into fast recovery, during which the sender can only transmit new data for every duplicate ACK received.

FIG. 6C shows the queue size of the bottleneck's buffer in bytes on the vertical axis for only 5 seconds on the horizontal axis of the simulation. This highlights the idle periods of each protocol. It can be seen from the figure that TCP has more extended idle periods compared to NDTP. As a result, NDTP achieved higher average throughput due to better utilization of the link's capacity and the buffer size.

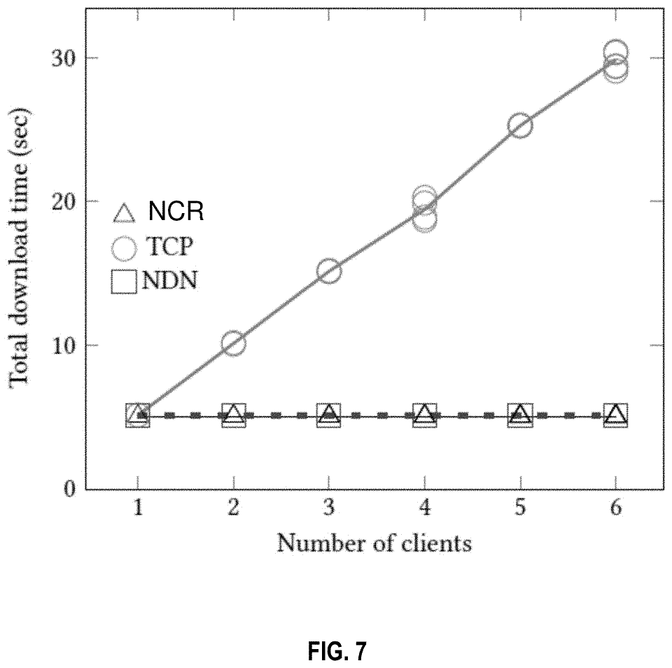

The total average time taken to retrieve multiple copies of a large data file was compared using NDT, TCP, and NDN. The experiment consists of a source node connected over a 10 Mbps shared link to a cluster of six consumers, all interconnected via 100 Mbps links. An intermediate router is configured to forward NDT traffic to a caching proxy for NDT traffic. The same topology was used for NDN as well. Both NDN and NDT use the same congestion control algorithm, which mimics the TCP congestion control algorithm to provide a fair comparison with TCP. The scenario was run six times, and each time the number of consumers in the network was increased. All consumers start pulling a 6 MB data file from the source simultaneously, and the total download time for every consumer is displayed in FIG. 7.

FIG. 7 is a plot that illustrates example performance compared to TCP, according to an embodiment. The vertical axis indicates the time to download a file of fixed size in seconds; and, the horizontal axis indicates the number of consumers. As can be observed from FIG. 7, TCP, NDT, and NDN perform very much the same when a single consumer is involved. This is to be expected, given that most of the NDT and NDN data packets are retrieved from the source in this case, and all three approaches use similar algorithms for congestion control. As the number of consumers increases, the completion times in NDT and NDN remain constant for all six scenarios. In contrast, the completion time in TCP increases linearly because all the data must be retrieved from the source. The use of PIT's in NDT and NDN results in only the first consumer Interests traversing the path to the producer, while the rest of the Interests are simply added to the PIT of the first router in NDN and the caching proxy in NDT.

This scenario highlights NDT's ability to take advantage of in network caching as NDN does, but without requiring any changes to the IP routing infrastructure.

How NDT's architectural components work together was analyzed to provide efficient name-based content delivery over the existing IP Internet. The total average time taken to retrieve a large data file was compared in three cases, namely: using only the transparent caching enabled by NDT proxies (NP), using redirection to nearest mirroring sites based on my-DNS without transparent caching at NPs, and using NPs together with redirection to nearest mirroring site based on my-DNS.

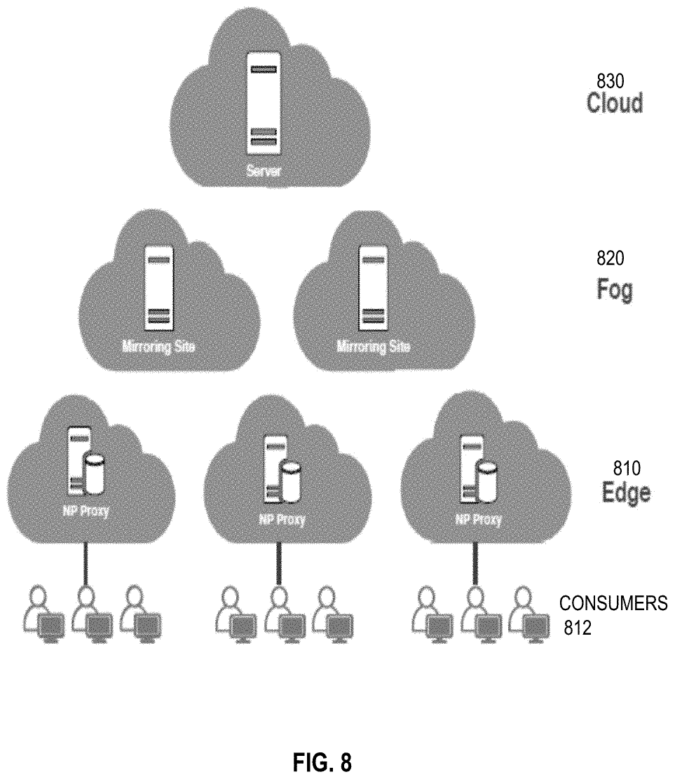

FIG. 8 is a block diagram that illustrates example network topology with proxy content servers according to an embodiment. FIG. 8 shows the topology used in this scenario, which consists of multiple edge networks 810 connected by a cluster of multiple consumers 812 and mirroring sites (Fog 820) located between the edge 810 and the cloud network 830 where the content server is located. Each edge router is connected to NDT proxies that provide transparent caching for NDT traffic passing through them. When my-DNS is enabled, Interests from consumers are routed to the nearest mirroring site for the content. Each experiment was run five times and the number of consumers in each cluster was increased. Each consumer starts pulling a 6 MB data file from the producer at a random start time based on a Poisson distribution with a short average arrival time.

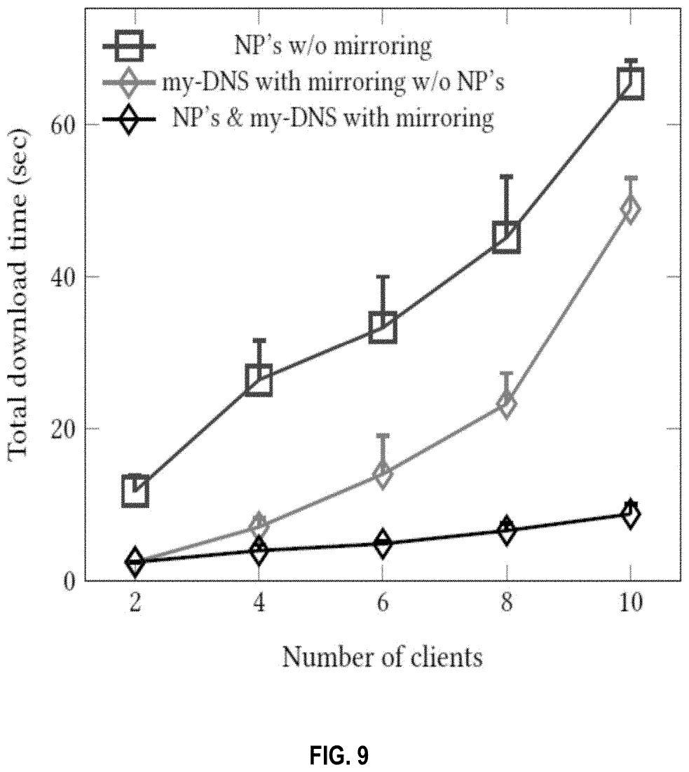

FIG. 9 is a plot that illustrates example performance, according to various embodiments. The horizontal axis indicates the number of content consumers; and, the vertical axis indicate the total download time in seconds. FIG. 9 shows the average latency incurred in retrieving the content object for each scenario, along with the variance. As expected, NDT performs its best when NDT proxies and nearest-replica routing through the my-DNS are used. As FIG. 9 indicates, when only NPs are used, Interests from consumers have to reach the producer site, and the benefits of using NPs come from aggregating Interests and caching content. However, because of the short inter-arrival time of Interests, only aggregation is useful. In this scenario with ten consumers, only two Interests for the same data object traverse the path to the producer. Using my-DNS without NPs results in a shorter retrieval time for consumers, but duplicate packets are sent along links. When both my-DNS and NPs are used, Interests from consumers are routed to the nearest mirroring site and aggregated at the NPs.

The overhead of mapping URLs to manifest records using my-DNS was also evaluated. The model is based on the HTTP application, where clients start requesting the main web page and then start requesting the embedded inline objects based on their URL in the web page. The main object size and the size of the embedded inline objects are based on the top one million visited web pages indicated in [78]. Two HTTP applications were used for this comparison. One HTTP application was based on persistent connections, in which a new HTTP request cannot be sent until the response to the current request is received. The other HTTP application was based on HTTP pipelining, where multiple HTTP requests can be sent together over a single TCP connection. For the case of NDT, each URL mapped to a single manifest record. The NDTP consumer starts querying the my-DNS for the manifest record of the main object, and it queries for the inline objects records after retrieving the main object from the server.

The topology of the network is a single path of four nodes with a single client connected to its local my-DNS server, and a content server at the other end that is connected to its authoritative my-DNS server. For the sake of simplicity, the IP address of the authoritative my-DNS server is cached at the local my-DNS server at the start of the simulation. Both resource and manifest records are retrieved from the authoritative my-DNS server at the other end if they are not cached. For a fair comparison between NDT and HTTP over TCP, both NDT and TCP have the same fixed-header size, the same chunk and segment size, and the same congestion control algorithm.

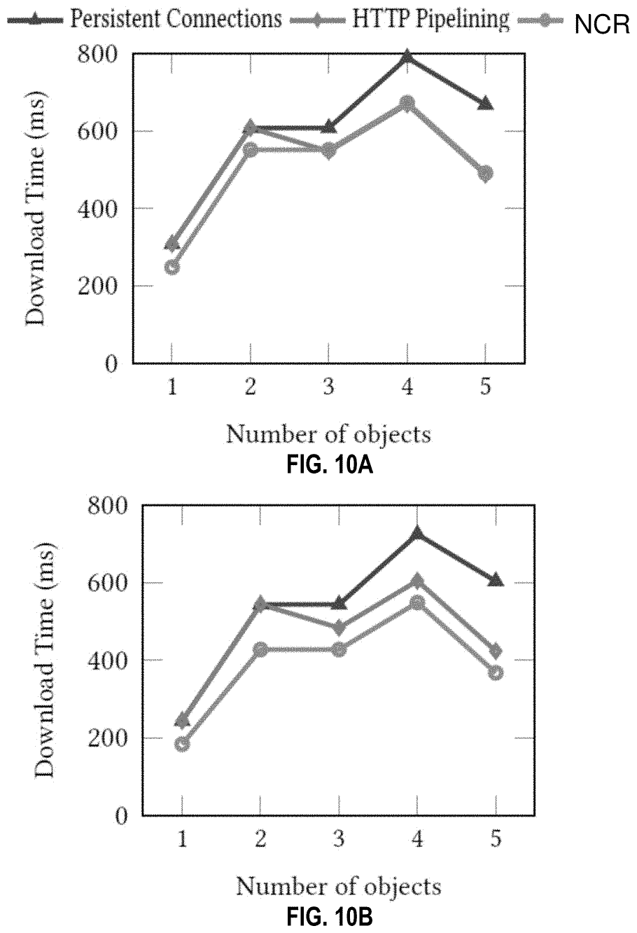

FIG. 10A and FIG. 10B are plots that illustrate example performance using cached and non-cached CNS records, respectively, according to various embodiments. In each plot, the horizontal axis indicates number of objects to download; and, the vertical axis indicates download time in milliseconds (ms). As FIG. 10A shows, NDT performs at least as well as HTTP pipelining. Both HTTP applications require a connection to be established using TCP three-way handshakes before a client can start sending and receiving data. By contrast, NDTP allows clients to retrieve data without the need to establish a connection, which reduces the number of RTTs by at least one compared to TCP. Multiplexing is easily supported in NDTP because objects in NDTP are globally named and pointed by their own manifest, allowing consumers to pipeline and multiplex multiple objects together. As seen in FIG. 10B, when manifest records are cached, NDT outperformed both types of HTTP. This proves that using my-DNS to translate URLs as structured in applications like HTTP do not impose significant overhead in NDT.

Compared to NDN, using my-DNS in NDT does not impose significant overhead either. A consumer in NDN still has to retrieve the manifest from the producer before issuing Interests to retrieve the content. Retrieving the manifest record using my-DNS will only infer a small delay at minimum. Even if the delay to the my-DNS is long, the transaction to retrieve the manifest record for a content happens only once.

To examine TCP friendliness in NDTP, a scenario in which caching takes place and a second scenario without caching were considered. The topology of the network consists of a bottleneck link of capacity 1 Mbps and a buffer size of 20 packets. For the sake of simplicity, the chunk size of NDTP is fixed at 1000 bytes, and the same goes for the segment size of TCP. TCP operates with the SACK option enabled, and ACKs are not delayed. Both TCP and NDTP have the same round-trip-time delay, and they are retrieving the same file of about 3 MB in size. For the scenario with cashing, NDT caching proxies are configured in the topology before the bottleneck. This allows the NDT caching proxy to serve the consumer Interests for dropped data packets due to congestion along the bottleneck. Initially, the NDT caching proxy is empty and caches any data packets that pass through it. A router is configured to interrupt NDTP packets based on the protocol number and redirect them to the NDT caching proxy.

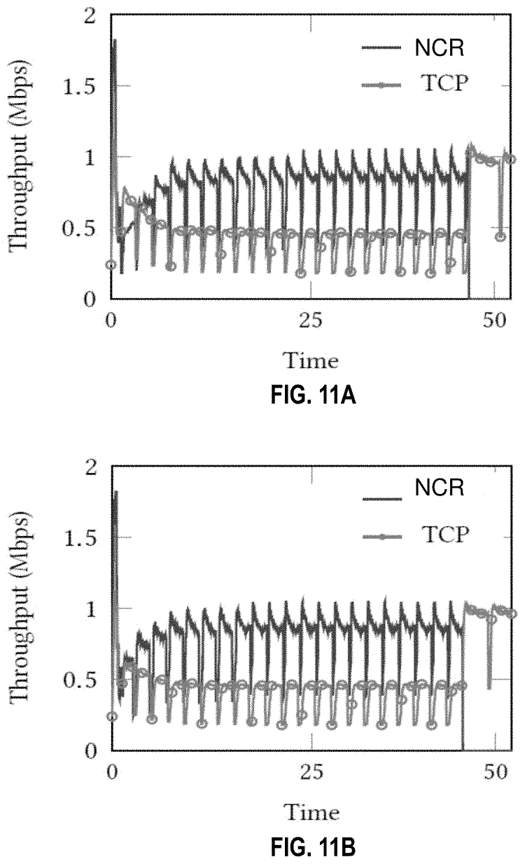

FIG. 11A and FIG. 11B are plots that illustrate example throughput performance over TCP using cached and non-cached chunks, respectively, according to various embodiments. In each plot, the horizontal axis indicates time in seconds from zero to fifty seconds; and the vertical axis indicates throughput in Mbps from zero to two. FIG. 11A shows the results without caching. FIG. 11B shows the results with caching. Using Jain's fairness index, the fairness between the two flows without caching is F=0.9988, which is understandable because NDTP also follows an AIMD congestion control algorithm like TCP. Similar results occur when caching takes place. The results illustrate that caching does not have a large negative effect on fairness. In fact, fairness between the two flows was F=0.9967 with caching. This is due to the ability of NDTP to detect that most packets were retrieved from the primary source, and control its sending rate accordingly. Even though NDTP achieved less fairness than two competing TCP flows under the same scenario (where fairness F=0.999996), the total download time for TCP flows retrieving the same file size was higher by 8.5%.

The results of simulation experiments in ns-3 show that: (a) NDT is inherently more efficient than TCP, (b) the performance of NDT and NDN is very similar, and (c) NDT outperforms HTTP over TCP while being able to provide privacy.

Congestion and retransmission control algorithms were implemented in NDT that are similar to those used in TCP simply to highlight the inherent benefits of the name-based connectionless approach used in NDTP. Far more efficient algorithms can be adapted to be used in NDTP in some embodiments, including many that have been proposed for TCP recently [14, 15]. Similarly, in other embodiments, other mechanisms to secure content and manifest records ae used. Even more efficient native multicast mechanisms are also used in other embodiments.

Performance experiments focused on static content of NDT; however, the approaches that have been described for the support of realtime voice and video-conferencing in NDN and CCN [51, 56] are equally applicable to the end-to-end information-centric approach in NDT.

### 3. Computational Hardware Overview

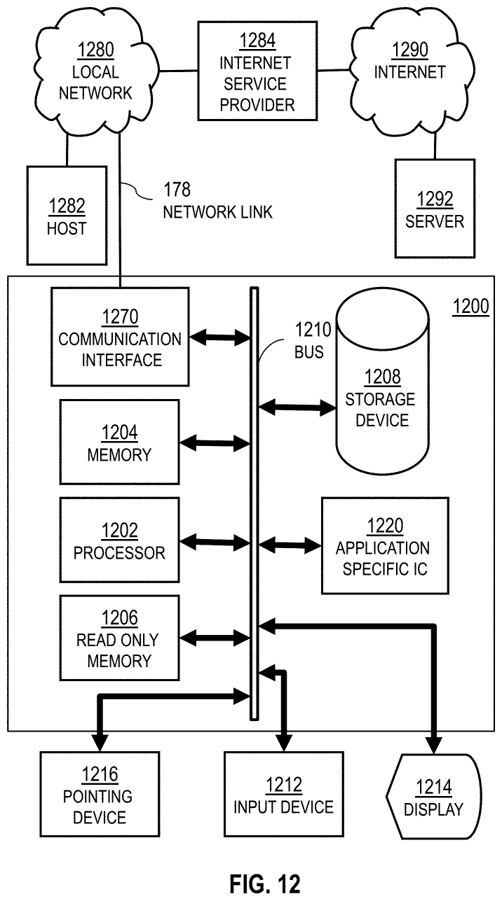

FIG. 12 is a block diagram that illustrates a computer system 1200 upon which an embodiment of the invention may be implemented. Computer system 1200 includes a communication mechanism such as a bus 1210 for passing information between other internal and external components of the computer system 1200. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1200, or a portion thereof, constitutes a means for performing one or more steps of one or more methods described herein.

A sequence of binary digits constitutes digital data that is used to represent a number or code for a character. A bus 1210 includes many parallel conductors of information so that information is transferred quickly among devices coupled to the bus 1210. One or more processors 1202 for processing information are coupled with the bus 1210. A processor 1202 performs a set of operations on information. The set of operations include bringing information in from the bus 1210 and placing information on the bus 1210. The set of operations also typically include comparing two or more units of information, shifting positions of units of information, and combining two or more units of information, such as by addition or multiplication. A sequence of operations to be executed by the processor 1202 constitutes computer instructions.

Computer system 1200 also includes a memory 1204 coupled to bus 1210. The memory 1204, such as a random access memory (RAM) or other dynamic storage device, stores information including computer instructions. Dynamic memory allows information stored therein to be changed by the computer system 1200. RAM allows a unit of information stored at a location called a memory address to be stored and retrieved independently of information at neighboring addresses. The memory 1204 is also used by the processor 1202 to store temporary values during execution of computer instructions. The computer system 1200 also includes a read only memory (ROM) 1206 or other static storage device coupled to the bus 1210 for storing static information, including instructions, that is not changed by the computer system 1200. Also coupled to bus 1210 is a non-volatile (persistent) storage device 1208, such as a magnetic disk or optical disk, for storing information, including instructions, that persists even when the computer system 1200 is turned off or otherwise loses power.

Information, including instructions, is provided to the bus 1210 for use by the processor from an external input device 1212, such as a keyboard containing alphanumeric keys operated by a human user, or a sensor. A sensor detects conditions in its vicinity and transforms those detections into signals compatible with the signals used to represent information in computer system 1200. Other external devices coupled to bus 1210, used primarily for interacting with humans, include a display device 1214, such as a cathode ray tube (CRT) or a liquid crystal display (LCD), for presenting images, and a pointing device 1216, such as a mouse or a trackball or cursor direction keys, for controlling a position of a small cursor image presented on the display 1214 and issuing commands associated with graphical elements presented on the display 1214.

In the illustrated embodiment, special purpose hardware, such as an application specific integrated circuit (IC) 1220, is coupled to bus 1210. The special purpose hardware is configured to perform operations not performed by processor 1202 quickly enough for special purposes. Examples of application specific ICs include graphics accelerator cards for generating images for display 1214, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1200 also includes one or more instances of a communications interface 1270 coupled to bus 1210. Communication interface 1270 provides a two-way communication coupling to a variety of external devices that operate with their own processors, such as printers, scanners and external disks. In general the coupling is with a network link 1278 that is connected to a local network 1280 to which a variety of external devices with their own processors are connected. For example, communication interface 1270 may be a parallel port or a serial port or a universal serial bus (USB) port on a personal computer. In some embodiments, communications interface 1270 is an integrated services digital network (ISDN) card or a digital subscriber line (DSL) card or a telephone modem that provides an information communication connection to a corresponding type of telephone line. In some embodiments, a communication interface 1270 is a cable modem that converts signals on bus 1210 into signals for a communication connection over a coaxial cable or into optical signals for a communication connection over a fiber optic cable. As another example, communications interface 1270 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1270 sends and receives electrical, acoustic or electromagnetic signals, including infrared and optical signals, that carry information streams, such as digital data.

The term computer-readable medium is used herein to refer to any medium that participates in providing information to processor 1202, including instructions for execution. Such a medium may take many forms, including, but not limited to, non-volatile media, volatile media and transmission media. Non-volatile media include, for example, optical or magnetic disks, such as storage device 1208. Volatile media include, for example, dynamic memory 1204. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1202, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1202, except for carrier waves and other signals.

Logic encoded in one or more tangible media includes one or both of processor instructions on a computer-readable storage media and special purpose hardware, such as ASIC 1220.

Network link 1278 typically provides information communication through one or more networks to other devices that use or process the information. For example, network link 1278 may provide a connection through local network 1280 to a host computer 1282 or to equipment 1284 operated by an Internet Service Provider (ISP). ISP equipment 1284 in turn provides data communication services through the public, world-wide packet-switching communication network of networks now commonly referred to as the Internet 1290. A computer called a server 1292 connected to the Internet provides a service in response to information received over the Internet. For example, server 1292 provides information representing video data for presentation at display 1214.

The invention is related to the use of computer system 1200 for implementing the techniques described herein. According to one embodiment of the invention, those techniques are performed by computer system 1200 in response to processor 1202 executing one or more sequences of one or more instructions contained in memory 1204. Such instructions, also called software and program code, may be read into memory 1204 from another computer-readable medium such as storage device 1208. Execution of the sequences of instructions contained in memory 1204 causes processor 1202 to perform the method steps described herein. In alternative embodiments, hardware, such as application specific integrated circuit 1220, may be used in place of or in combination with software to implement the invention. Thus, embodiments of the invention are not limited to any specific combination of hardware and software.

The signals transmitted over network link 1278 and other networks through communications interface 1270, carry information to and from computer system 1200. Computer system 1200 can send and receive information, including program code, through the networks 1280, 1290 among others, through network link 1278 and communications interface 1270. In an example using the Internet 1290, a server 1292 transmits program code for a particular application, requested by a message sent from computer 1200, through Internet 1290, ISP equipment 1284, local network 1280 and communications interface 1270. The received code may be executed by processor 1202 as it is received, or may be stored in storage device 1208 or other non-volatile storage for later execution, or both. In this manner, computer system 1200 may obtain application program code in the form of a signal on a carrier wave.

Various forms of computer readable media may be involved in carrying one or more sequence of instructions or data or both to processor 1202 for execution. For example, instructions and data may initially be carried on a magnetic disk of a remote computer such as host 1282. The remote computer loads the instructions and data into its dynamic memory and sends the instructions and data over a telephone line using a modem. A modem local to the computer system 1200 receives the instructions and data on a telephone line and uses an infra-red transmitter to convert the instructions and data to a signal on an infra-red a carrier wave serving as the network link 1278. An infrared detector serving as communications interface 1270 receives the instructions and data carried in the infrared signal and places information representing the instructions and data onto bus 1210. Bus 1210 carries the information to memory 1204 from which processor 1202 retrieves and executes the instructions using some of the data sent with the instructions. The instructions and data received in memory 1204 may optionally be stored on storage device 1208, either before or after execution by the processor 1202.

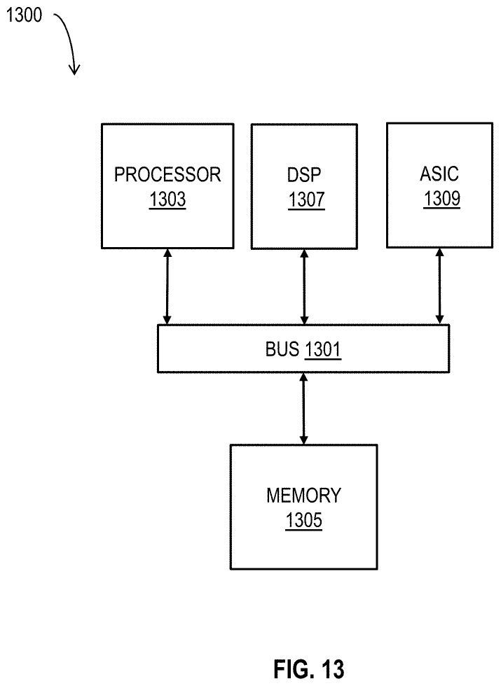

FIG. 13 illustrates a chip set 1300 upon which an embodiment of the invention may be implemented. Chip set 1300 is programmed to perform one or more steps of a method described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1300, or a portion thereof, constitutes a means for performing one or more steps of a method described herein.

In one embodiment, the chip set 1300 includes a communication mechanism such as a bus 1301 for passing information among the components of the chip set 1300. A processor 1303 has connectivity to the bus 1301 to execute instructions and process information stored in, for example, a memory 1305. The processor 1303 may include one or more processing cores with each core configured to perform independently. A multi-core processor enables multiprocessing within a single physical package. Examples of a multi-core processor include two, four, eight, or greater numbers of processing cores. Alternatively or in addition, the processor 1303 may include one or more microprocessors configured in tandem via the bus 1301 to enable independent execution of instructions, pipelining, and multithreading. The processor 1303 may also be accompanied with one or more specialized components to perform certain processing functions and tasks such as one or more digital signal processors (DSP) 1307, or one or more application-specific integrated circuits (ASIC) 1309. A DSP 1307 typically is configured to process real-world signals (e.g., sound) in real time independently of the processor 1303. Similarly, an ASIC 1309 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1303 and accompanying components have connectivity to the memory 1305 via the bus 1301. The memory 1305 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1305 also stores the data associated with or generated by the execution of one or more steps of the methods described herein.

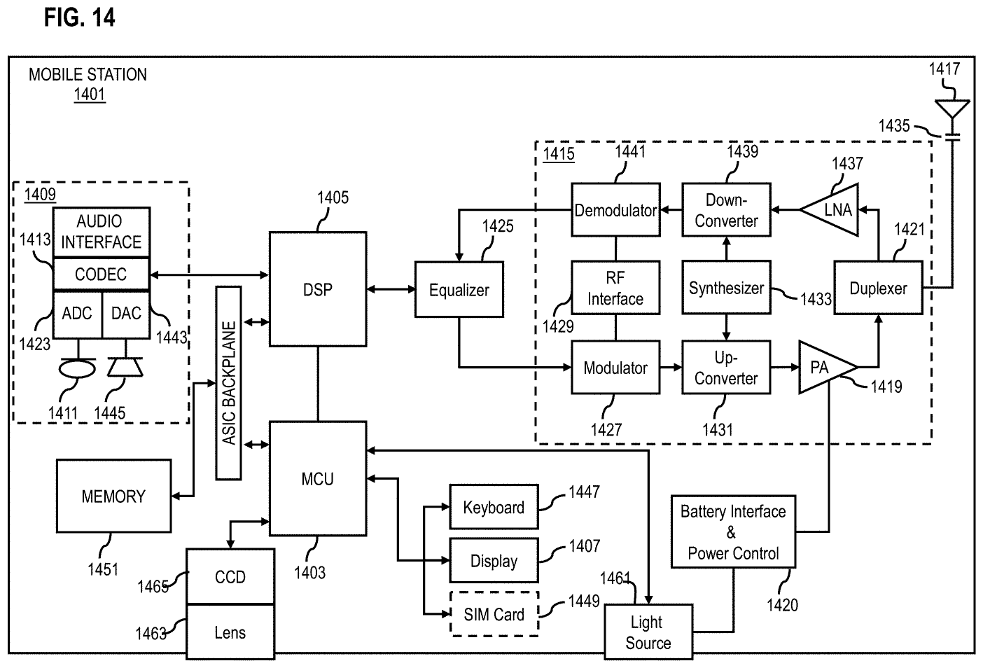

FIG. 14 is a diagram of example components of a mobile terminal 1400 (e.g., cell phone handset) for communications, which is capable of operating in the system of FIG. 1, according to one embodiment. In some embodiments, mobile terminal 1401, or a portion thereof, constitutes a means for performing one or more steps described herein. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1403, a Digital Signal Processor (DSP) 1405, and a receiver/transmitter unit including a microphone gain control unit and a speaker gain control unit. A main display unit 1407 provides a display to the user in support of various applications and mobile terminal functions that perform or support the steps as described herein. The display 1407 includes display circuitry configured to display at least a portion of a user interface of the mobile terminal (e.g., mobile telephone). Additionally, the display 1407 and display circuitry are configured to facilitate user control of at least some functions of the mobile terminal. An audio function circuitry 1409 includes a microphone 1411 and microphone amplifier that amplifies the speech signal output from the microphone 1411. The amplified speech signal output from the microphone 1411 is fed to a coder/decoder (CODEC) 1413.

A radio section 1415 amplifies power and converts frequency in order to communicate with a base station, which is included in a mobile communication system, via antenna 1417. The power amplifier (PA) 1419 and the transmitter/modulation circuitry are operationally responsive to the MCU 1403, with an output from the PA 1419 coupled to the duplexer 1421 or circulator or antenna switch, as known in the art. The PA 1419 also couples to a battery interface and power control unit 1420.

In use, a user of mobile terminal 1401 speaks into the microphone 1411 and his or her voice along with any detected background noise is converted into an analog voltage. The analog voltage is then converted into a digital signal through the Analog to Digital Converter (ADC) 1423. The control unit 1403 routes the digital signal into the DSP 1405 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1425 for compensation of any frequency-dependent impairments that occur during transmission though the air such as phase and amplitude distortion. After equalizing the bit stream, the modulator 1427 combines the signal with a RF signal generated in the RF interface 1429. The modulator 1427 generates a sine wave by way of frequency or phase modulation. In order to prepare the signal for transmission, an up-converter 1431 combines the sine wave output from the modulator 1427 with another sine wave generated by a synthesizer 1433 to achieve the desired frequency of transmission. The signal is then sent through a PA 1419 to increase the signal to an appropriate power level. In practical systems, the PA 1419 acts as a variable gain amplifier whose gain is controlled by the DSP 1405 from information received from a network base station. The signal is then filtered within the duplexer 1421 and optionally sent to an antenna coupler 1435 to match impedances to provide maximum power transfer. Finally, the signal is transmitted via antenna 1417 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1401 are received via antenna 1417 and immediately amplified by a low noise amplifier (LNA) 1437. A down-converter 1439 lowers the carrier frequency while the demodulator 1441 strips away the RF leaving only a digital bit stream. The signal then goes through the equalizer 1425 and is processed by the DSP 1405. A Digital to Analog Converter (DAC) 1443 converts the signal and the resulting output is transmitted to the user through the speaker 1445, all under control of a Main Control Unit (MCU) 1403 which can be implemented as a Central Processing Unit (CPU) (not shown).

The MCU 1403 receives various signals including input signals from the keyboard 1447. The keyboard 1447 and/or the MCU 1403 in combination with other user input components (e.g., the microphone 1411) comprise a user interface circuitry for managing user input. The MCU 1403 runs a user interface software to facilitate user control of at least some functions of the mobile terminal 1401 as described herein. The MCU 1403 also delivers a display command and a switch command to the display 1407 and to the speech output switching controller, respectively. Further, the MCU 1403 exchanges information with the DSP 1405 and can access an optionally incorporated SIM card 1449 and a memory 1451. In addition, the MCU 1403 executes various control functions required of the terminal. The DSP 1405 may, depending upon the implementation, perform any of a variety of conventional digital processing functions on the voice signals. Additionally, DSP 1405 determines the background noise level of the local environment from the signals detected by microphone 1411 and sets the gain of microphone 1411 to a level selected to compensate for the natural tendency of the user of the mobile terminal 1401.

The CODEC 1413 includes the ADC 1423 and DAC 1443. The memory 1451 stores various data including call incoming tone data and is capable of storing other data including music data received via, e.g., the global Internet. The software module could reside in RAM memory, flash memory, registers, or any other form of writable storage medium known in the art. The memory device 1451 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1449 carries, for instance, important information, such as the cellular phone number, the carrier supplying service, subscription details, and security information. The SIM card 1449 serves primarily to identify the mobile terminal 1401 on a radio network. The card 1449 also contains a memory for storing a personal telephone number registry, text messages, and user specific mobile terminal settings.

In some embodiments, the mobile terminal 1401 includes a digital camera comprising an array of optical detectors, such as charge coupled device (CCD) array 1465. The output of the array is image data that is transferred to the MCU for further processing or storage in the memory 1451 or both. In the illustrated embodiment, the light impinges on the optical array through a lens 1463, such as a pin-hole lens or a material lens made of an optical grade glass or plastic material. In the illustrated embodiment, the mobile terminal 1401 includes a light source 1461, such as a LED to illuminate a subject for capture by the optical array, e.g., CCD 1465. The light source is powered by the battery interface and power control module 1420 and controlled by the MCU 1403 based on instructions stored or loaded into the MCU 1403.

### 3. Alternatives, Deviations and Modifications

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5× to 2×, for example, about 100 implies a value in a range from 130 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 12.

### 4. References

The references cited here are hereby incorporated by reference as if fully set forth herein, except for terminology inconsistent with that used herein.
[1] A. Afanasyev et al., ndnSIM: NDN simulator for NS-3. Technical Report NDN-0005. (NDNsim)
[2] B. Ahlgren et al, “A Survey of Information-Centric Networking,” IEEE Commun. Magazine, July 2012, pp. 26-36.
[3] A. Albalawi and J. J. Garcia-Luna-Aceves, “A Delay-Based Congestion
[4] A. Albalawi and J. J. Garcia-Luna-Aceves, “NCT ns-3 Simulator.” Available on a browser at domain github, superdomain corn, folder aalbalaw, file NCT.
[5] S. Arianfar et al., “On Preserving Privacy in Content-Oriented Networks,” Proc. ACM SIGCOMM Workshop on Information-Centric Networking, 2011.
[6] S. Ariyapperuma and C. Mitchell, “Security vulnerabilities in DNS and DNSSEC,” Proc. IEEE ARES '07, April 2007.
[7] R. Atkinson, S. Bhatti, and S. Hailes. “ILNP: Mobility, Multi-homing, Localised Addressing and Security through Naming,” Telecommunication Systems, 2009.
[8] P. Baran, “On Distributed Communications Networks,” IEEE Trans. Communications Systems, March 1964.
[9] M. F. Bari et al, “ASurvey of Naming and Routing in Information-Centric Networks,” IEEE Commun. Magazine, July 2012, pp. 44-53.
[10] N. Bartolini, E. Casalicchio, and S. Tucc, “A Walk through Content Delivery Networks,” Proc. IEEE MASCOTS '03, 2003.
[11] M. Baugher et al., “Self-Verifying Names for Read-Only Named content,” Proc. IEEE INFOCOM Workshops '12, March 2012.
[12] BitTorrent. Available on a browser at domain bittorrent, superdomain corn.
[13] M. S. Blumenthal and D. D. Clark, “Rethinking the Design of the Internet: The End-to-End Arguments vs. the Brave New World,” ACM Trans. on Internet Technology, August 2001.
[14] N. Cardwell et al., “BBR: congestion-based congestion control,” ACM, February 2017.
[15] N. Cardwell et al., “Model-based Network Congestion Control,” Technical Disclosure Commons, Mar. 27, 2019.
[16] G. Caro“glio, M. Gallo, and L. Muscariello, “ICP: Design and Evaluation of an Interest Control Protocol for Content-Centric Networking,” Proc. IEEE NOMEN '12, March 2012.
[17] G. Caro“glio et al., “Enabling ICN in the Internet Protocol: Analysis and Evaluation of the Hybrid-ICN Architecture,” Proc. ACM ICN '19, September 2019.
[18] A. Carzaniga, D. S. Rosenblum, and A. L. Wolf, “Achieving Scalability and Expressiveness in an Internet-Scale Event Notification Service,” Proc. ACM PODC '20, 2000.
[19] A. Carzaniga, D. S. Rosenblum, and A. L. Wolf, “Content-based Addressing and Routing: A General Model and Its Application,” Tech. Report CU-CS-902-00, Univ. of Colorado, January 2000.
[20] A. Carzaniga and A. L. Wolf, “Content-Based Networking: A New Communication Infrastructure,” Proc. Workshop on Infrastructure for Mobile and Wireless Systems, 2002.
[21] V. G. Cerf, Y. K. Dalal, and C. A. Sunshine, “Speci”cation of Internet Transmission Control Program,” INWG Note 72, revised December 1974.
[22] Q. Chen et al., “Transport Control Strategies in Named content Networking: A Survey,” IEEE Communications Surveys and Tutorials, 2016.
[23] X. Chen et al., “Maintaining Strong Cache Consistency for the Domain Name System,” IEEE Trans. on Knowledge and Data Engineering, August 2007
[24] S. Cheshire, J. Graessley, and R. McGuire, “Encapsulation of TCP and other transport protocols over UDP,” Internet Draft, July 2013.
[25] A. Dabirmoghaddam, M. M. Barijough, and J. J. Garcia-Luna-Aceves, “Understanding Optimal Caching and Opportunistic Caching at the Edge of Information-Centric Networks,” Proc. ACM ICN '14, Paris, France, September 2014.
[26] A. Dabirmoghaddam, M. Dehghan, and J. J. Garcia-Luna-Aceves, “Characterizing Interest Aggregation in Content-Centric Networks,” Proc. IFIP Networking 2016, Vienna, Austria, May 17-19, 2016.
[27] S. E. Deering and D. R. Cheriton, “Multicast Routing in Datagram Internetwork and Extended LANs,” ACM TOCS, May 1990.
[28] E. Demirors and C. Westphal, “DNS++: A Manifest Architecture for Enhanced Content-Based Traffc Engineering,” Proc. IEEE GLOBECOM '17, 2017.
[29] T. Dierks, “The Transport Layer Security (TLS) Protocol Version 1.2,” 2008.
[30] D. E. Eastlake 3rd, “Domain Name System Security Extensions,” RFC 2535, 1999.
[31] W. M. Eddy, “At What layer Does Mobility Belong?,” IEEE Comm. Magazine, 2004.
[32] A. Eriksson and A. Mohammad Malik, “A DNS-Based Information-Centric Network Architecture Open to Multiple Protocols for Transfer of Data Objects, Proc. IEEE ICIN '18, 2018.
[33] S. K. Fayazbakhsh et al., “Less Pain, Most of the Gain: Incrementally Deployable ICN,” Proc. ACM SIGCOMM '13, 2013.
[34] D. Florez-Rodriguez et al., “Global Architecture of the COMET System,” Seventh Framework STREP No. 248784, 2013.
[35] FP7 COMET project. Available on a browser at subdomain www, domain comet project, superdomain org.
[36] FP7 PSIRP project. Available on a browser at subdomain www, domain psirp, superdomain org.
[37] FP7 PURSUIT project. Available on a browser at subdomain www domain fp7-pursuit, superdomain eu, folder PursuitWeb.
[38] FP7 SAIL project. Available on a browser at subdomain www domain sail-project, superdomain eu.
[39] FP7 4WARD project. Available on a browser at subdomain www domain 4ward-project, superdomain eu.
[40] FP7 CONVERGENCE project. Available on a browser at subdomain www domain ictconvergence, superdomain eu.
[41] Z. Gao, A. Venkataramani, and J. F. Kurose, “Towards a Quantitative Comparison of Location-Independent Network Architectures,” ACM SIGCOMM Computer Communication Review, 2014.
[42] J. J. Garcia-Luna-Aceves, “System and Method for Discovering Information Objects and Information Object Repositories in Computer Networks,” U.S. Pat. No. 7,162,539, Jan. 9, 2007.
[43] J. J. Garcia-Luna-Aceves, “Name-Based Content Routing in Information Centric Networks Using Distance Information,” Proc. ACM ICN '14, September, 2014.
[44] J. J. Garcia-Luna-Aceves, Q. Li, and Turhan Karadeniz, “CORD: Content Oriented Routing with Directories,” Proc. IEEE ICNC '15, February 2015.
[45] J. J. Garcia-Luna-Aceves and M. Mirzazad-Barijough, “Content-Centric Networking Using Anonymous Datagrams,” Proc. IFIP Networking '16, May 2016.
[46] J. J. Garcia-Luna-Aceves, M. Mirzazad-Barijough, and E. Hemmati, “Content-Centric Networking at Internet Scale through The Integration of Name Resolution and Routing,” Proc. ACM ICN '16, Kyoto, Japan, September 2016.
[47] C. Ghasemi et al., “MUCA: New Routing for Named content Networking,” Proc. IFIP Networking '18, May 2018.
[48] D. K. Gifiord, “Replica Routing,” U.S. Pat. No. 6,052,718, Apr. 18, 2000.
[49] M. Gritter and D. Cheriton, “An Architecture for Content Routing Support in The Internet,” Proc. USENIX Symposium on Internet Technologies and Systems, September 2001.
[50] Y. Gu and R. Grossman, “UDT: UDP-Based Data Transfer for High-Speed Wide Area Networks,” Computer Networks, Elsevier, Volume 51, Issue 7, 2007.
[51] P. Gusev and J. Burke, “NDN-RTC: Real-Time Videoconferencing over Named content Networking,” Proc. ACM ICN '15, September 2015.
[52] E. Hemmati and J. J. Garcia-Luna-Aceves, “A New Approach to Name-Based Link-State Routing for Information-Centric Networks,” Proc. ACM ICN '15, September 2015.
[53] P. Hofiman and J. Schlyter, “The DNS-Based Authentication of Named Entities (DANE) Transport Layer Security (TLS) Protocol: TLSA,” RFC 6698, 2012.
[54] V. Jacobson, “Congestion Avoidance and Control, Proc. ACM SIGCOMM '88, August 1988.
[55] V. Jacobson et al., “Networking Named Content,” Proc. ACM CoNEXT '09, December 2009.
[56] V. Jacobson et al., “VoCCN: Voice-over Content-Centric Networks,” Proc. ACM ReArch '09, December 2009.
[57] E. Kohler, M. Handley, and S. Floyd, “Datagram Congestion Control Protocol (DCCP),” RFC 4340, IETF, March 2006.
[58] T. Koponen et al., “A Data-Oriented (and Beyond) Network Architecture,” Proc. ACM SIGCOMM '07, August 2007.
[59] A. Langley et al., “The QUIC Transport Protocol: Design and Internet-Scale Deployment,” Proc. ACM SIGCOMM '17, August 2017.
[60] D. Le, X. Fu, and D. Hogrefe, “A Review of Mobility Support Paradigms for the Internet, IEEE Commun. Surveys & Tutorials, 2006.
[61] B. N. Levine et al., “Consideration of Receiver Interest for IP Multicast Delivery,” Proc. IEEE Infocom '00, March 2000.
[62] J. Li, “On peer-to-peer (P2P) content delivery,” Peer-to-Peer Netw. Appl., 2008.
[63] E. K. Lua et al., “A Survey and Comparison of Peer-to-Peer Overlay Network Schemes,” IEEE Comm. Survey and Tutorial, March 2004.
[64] N. A. Lynch, Y. Mansour, and A. Fekete, “Data link layer: two impossibility Results,” Proc. ACM PODC '88, 1988.
[65] N. A. Lynch, Distributed Algorithms, Morgan Kaufiman, 1996.
[66] P. Mockapetris, “Domain Names—Implementation and Speci”cation,” RFC 1035, November 1987.
[67] I. Moiseenko and L. Zhang. “Consumer-producer API for Named content Networking,” Proc. ACM ICN '14, 2014.
[68] I. Moiseenko, “Fetching content in Named content Networking with embedded Manifests,” 2014.
[69] M. Mosko, I. Solis, E. Uzun, C. Wood, “CCNx 1.0 Protocol Architecture,” Xerox PARC, April 2017.
[70] L. Muscariello et al., “Hybrid Information-Centric Networking,” IETF Internet Draft, Oct. 30, 2019.
[71] NSF Named content Networking project. Available on a browser at subdomain www, domain named content, superdomain net.
[72] NSF Mobility First project. Available on a browser at subdomain rnobility“rst.winlab, domain rutgers, superdomain edu.
[73] E. Nygren, R. K. Sitaraman, and J. Sun, “The Akamai Network: A Platform for High-Performance Internet Applications,” ACM SIGOPS Operating Systems Review, August 2010.
[74] G. Papastergiou et al., “De-ossifying the Internet Transport Layer: A Survey and Future Perspectives,” IEEE Commun. Surveys & Tutorials, November 2016.
[75] R. Peon, “Explicit proxies for HTTP/2.0,” IETF Informational Internet Draft, 2012.
[76] E. Perera, V. Sivaraman, and A. Seneviratne, “Survey on Network Mobility Support,” ACM SIGMOBILE Mobile Computing and Commun. Review, 2004.
[77] M. Polese et al., “A Survey on Recent Advances in Transport Layer Protocols,” IEEE Communications Surveys and Tutorials, August 2019.
[78] R. Pries, Z. Magyari, and P. Tran-Gia, “An HTTP Web Traffc Model based on the Top One Million Visited Web Pages,” Proc. IEEE Euro-NF Conference on Next Generation Internet '12, 2012.
[79] J. Raju, J. J. Garcia-Luna-Aceves and B. Smith, “System and Method for Information Object Routing in Computer Networks,” U.S. Pat. No. 7,552,233, Jun. 23, 2009.
[80] D. Saha et al., “Mobility Support in IP: A Survey of Related Protocols,” IEEE Network, 2004
[81] J. H. Saltzer, “End-to-End Arguments in System Design,” RFC 185, 1980.
[82] L. Saino, C. Cocora and G. Pavlou, “CCTCP: A Scalable Receiver-Driven Congestion Control Protocol for Content Centric Networking,” Proc. IEEE ICC '13, 2013.
[83] I. Seskar et al., “MobilityFirst Future Internet Architecture Project,” Proc. AINTEC '11, November 2011.
[84] S. Sevilla, P. Mahadevan, and J. J. Garcia-Luna-Aceves, “iDNS: Enabling Information Centric Networking Through The DNS,” Proc. IEEE INFOCOM Workshop on Name-Oriented Mobility '14, 2014.
[85] S. Sevilla and J. J. Garcia-Luna-Aceves, “Freeing The IP Internet Architecture from Fixed IP Addresses,” Proc. IEEE ICNP '15, November 2015.
[86] S. Sevilla, J. J. Garcia-Luna-Aceves, and H. Sadjadpour, “GroupSec: A New Security Model for the Web,” Proc. IEEE ICC '17, 2017.
[87] S. Sevilla and J. J. Garcia-Luna-Aceves, “A Deployable Identi”er-Locator Split Architecture,” Proc. IEEE/IFIP Networking '17, June 2017.
[88] J. M. Spinelli, “Reliable Communication on Data Links,” LIDS-P-1844, MIT, December 1988.
[89] A. Stubble“eld and D. Wallach, “Dagster: Censorship-Resistant Publishing Without Replication,” Rice University, Dept. of Computer Science, Tech. Rep. TR01-380, 2001.
[90] B. Tremblay et al., “(D.A.3) Final Harmonised SAIL Architecture,” Report FP7-ICT-2009-5-257448-SAIL/D-2.3, February 2013.
[91] F. Urbani, W. Dabbous, and A. Legout. (2011, November) NS3 DCE CCNx quick start. INRIA.
[92] P. Vixie et al., “Dynamic Updates in the Domain Name System,” IETF RFC 2136, 1997.
[93] L. Wang et al., “A Secure Link State Routing Protocol for NDN,” IEEE Access, March 2018.
[94] C. Westphal and E. Demirors, “An IP-Based Manifest Architecture for ICN,” ACM ICN Demo, September 2015.
[95] Y. Wu, J. Tuononen, and M. Latvala, “Performance Analysis of DNS with TTL Value 0 as Location Repository in Mobile Internet,” IEEE WCNC '07, March 2007.
[96] G. Xylomenos et al., “Caching and Mobility Support in a Publish-Subscribe Internet Architecture,” IEEE Communications Magazine, July 2012
[97] G. Xylomenos et al., “A Survey of Information-centric Networking Research,” IEEE Communication Surveys & Tutorials, July 2013.
[98] B. Zolfaghari et al., “Content Delivery Networks: State of the Art, Trends, and Future Roadmap,” ACM Computing Surveys, April 2020.
[99] C. Parsa and J. J. Garcia-Luna-Aceves, “Improving TCP Congestion Control over Internets with Heterogeneous Transmission Media,” Proc. IEEE ICNP '99, November 1999.
[100] D. C. Walden, “A System for Interprocess Communication in a Resource Sharing Computer Network,” CACM, April 1972.
[101] D. C. Walden, “Host-To-Host Protocols,” in Tutorial: A Practical View of Computer Communications Protocols (J. M McQuillan and V. G. Cerf, Ed.s), pp. 172-204, IEEE, 1978.

What is claimed is:

1. A content consumer method executed on a processor serving as a local node in a digital communications network, the method comprising:
sending a request packet from a client process on the local node to a server process on a remote node for content, wherein the content comprises a plurality of chunks,
in response to sending the request packet, receiving a manifest packet that includes a first reliable protocol payload that indicates a name for the content, a node identifier for a node that stores the content, and a manifest field that indicates a coding method to decode the content after the content is delivered in coded form and a list of chunk names of the plurality of chunks; and
sending, to the node that stores the content, an interest packet that includes a second reliable protocol payload that indicates the name for the content and a chunk name for each of one or more missing chunks of the plurality of chunks, wherein a missing chunk has not been successfully received at the local node.

2. The method as recited in claim 1, wherein at least one of the coding method or the list of chunk names is encrypted with a key unknown at any intermediate node in the digital communications network.

3. The method as recited in claim 1, wherein the second reliable protocol payload also indicates one or more chunks of the plurality of chunks, which chunks have been successfully received at the local node.

4. The method as recited in claim 1, further comprising, in response to sending the interest packet, receiving a data delivery packet that includes a third reliable protocol payload that indicates the name for the content and one coded chunk of the one or more missing chunks.

5. The method as recited in claim 4, wherein the one coded chunk is encrypted with a key unknown at any intermediate node in the digital communications network.

6. The method as recited in claim 1, further comprising, controlling a rate of sending the interest packet based on congestion in the network.

7. The method as recited in claim 6, wherein controlling the rate of sending the interest packet further comprises maintaining a value for a congestion window parameter, wherein the value defines a maximum number of outstanding interest packets allowed to be sent without receiving corresponding data delivery packets.

8. A content producer method executed on a processor serving as a local node in a digital communications network, the method comprising, in response to receiving content from a server process on the local node, wherein the content comprises a plurality of chunks:
storing the content on the local node;
generating a content name server (CNS) compatible name for the content and generating a plurality of chunk names for the plurality of chunks;
generating a manifest field that holds data that indicates the chunk names and a coding method of encoding of the chunks; and
causing the manifest field and the CNS-compatible name to be stored by a CNS node and a data packet that includes the manifest field and a node identifier for the node that stores the content to be sent by the CNS node in a first reliable protocol payload in reply to a request for the manifest for the CNS-compatible name.

9. The method as recited in claim 8, wherein the coding method includes data that indicates a number of chunks in the plurality of chunks to request and an order for requesting the plurality of chunks.

10. The method as recited in claim 8, wherein the name for the content is unique within the digital communications network.

11. The method as recited in claim 8, wherein the name for the content includes a port number and IP address of the server process on the local node.

12. The method as recited in claim 8, wherein the CNS node is the local node and the method further comprises, in response to receiving a request packet from a client process on a remote node for content, sending to the client process a manifest packet that includes a first reliable protocol payload that indicates the name for the content, a coding method to decode the content after the content is delivered in coded form, and a list of chunk names and corresponding sizes of the plurality of chunks.

13. A method as recited in claim 12, further comprising, in response to receiving an interest packet from the client process that includes a second reliable protocol payload that holds data that indicates the name for the content and a chunk name for each of one or more chunks of interest of the plurality of chunks; sending to the client process a data delivery packet that includes a third reliable protocol payload that indicates the name for the content and one coded chunk of the one or more chunks of interest.

14. The method as recited in claim 12, wherein the first reliable protocol payload also holds data that indicates a list of Internet protocol (IP) addresses of other nodes from which the content can be requested.

15. The method as recited in claim 12, wherein at least one of the coding method or the chunk names is encrypted with a decryption key known to the client process.

16. The method as recited in claim 12, wherein the second reliable protocol payload also holds data that indicates one or more chunks of the plurality of chunks, which chunks have been successfully received by the client process.

17. The method as recited in claim 8, wherein the CNS node is a Domain Name Server (DNS) node different from the local node.

18. The method as recited in claim 17, wherein the manifest field is encrypted with a key known to a client process at a remote node but not known to the CNS node.

19. A method as recited in claim 18, further comprising, in response to receiving an interest packet originating at the remote node hosting the client process, wherein the interest packet includes a third reliable protocol payload that indicates the CNS-compatible name for the content and a first chunk name for a first chunk of the plurality of chunks, sending a data delivery packet with a destination of the client process at the remote node, wherein the data delivery packet includes a fourth reliable protocol payload that indicates the CNS-compatible name for the content and the first chunk encoded.

20. A CNS method executed on a processor serving as a local content name server (CNS) node in a digital communications network, the method comprising:
receiving, from a first remote node, a manifest registration packet that includes a first reliable protocol payload that includes a manifest field for content that comprises a plurality of chunks, wherein the manifest field holds data that indicates a list of chunk names for the plurality of chunks and a coding method to decode the content after the content is delivered in coded form; and
storing locally in a named content delivery data structure
a CNS-compatible name in a content name field,
the manifest field, and
a node identifier of the first remote node in an address field.

21. The method as recited in claim 20, wherein the CNS node is a Domain Name Server (DNS) node.

22. The method as recited in claim 20, further comprising, in response to receiving, from a second remote node different from the first remote node, a request for the manifest for the CNS-compatible name in a second reliable protocol payload, sending a data packet that includes in a third reliable protocol payload the manifest field and a node identifier for a node that stores the content.

23. The method as recited in claim 20, further comprising, in response to receiving, from a second remote node different from the first remote node, a data packet with the CNS-compatible name in a second reliable protocol payload, adding an IP address of the second remote node to the named content delivery data structure.

24. The method as recited in claim 23, further comprising, in response to receiving, from a third remote node different from the first remote node and the second remote node, a request for the manifest for the CNS-compatible name in a third reliable protocol payload, sending to the third remote node a data packet that includes in a fourth reliable protocol payload the manifest field and a node identifier for a node that stores the content, wherein the node identifier is selected from the local named content delivery data structure and wherein the node identifier has a lowest cost among all addresses in the named content delivery data structure for communicating a data packet to the third remote node.

25. The method as recited in claim 22, wherein the manifest field is encrypted with a key known to a client process at the second remote node but not known to the local CNS node.

26. A proxy method executed on a processor serving as a local node in a digital communications network, the method comprising:
receiving, from a client process on a first remote node, an interest packet that includes an Internet Protocol (IP) header that indicates a different second remote node and a first reliable protocol payload that indicates a name for content, wherein the content comprises a plurality of chunks, and a transport cookie that indicates one or more missing chunks of the plurality of chunks, wherein a missing chunk has not been successfully received by the client process;
determining whether the missing chunk associated with the name for the content is stored locally;
when the missing chunk associated with the name for the content is not stored locally, then forwarding the interest packet to the second remote node; and
when the missing chunk associated with the name for the content is stored locally, then, instead of forwarding the interest packet to the second remote node, sending to the first remote node a data delivery packet that includes a second reliable protocol payload that indicates the name for the content and the missing chunk.

27. The method as recited in claim 26, further comprising, upon receiving a data delivery packet originating from the second remote node that includes a third reliable protocol payload that indicates the name for the content and one chunk:
storing locally the one chunk in association with the name for the content; and
forwarding the data delivery packet according to a destination address in an IP header of the data delivery packet.

28. A non-transitory computer-readable medium carrying a data structure that includes:
a first field that holds data that indicates a content name for content that comprises a plurality of data chunks;
a second field that holds data that indicates a plurality of names for the plurality of data chunks; and
a third field that holds data that indicates a method for decoding the plurality of chunks.

29. The non-transitory computer-readable medium as recited in claim 28, wherein the data structure further includes a fourth field that indicates a size for each chunk of the plurality of chunks.

30. The non-transitory computer-readable medium as recited in claim 28, wherein the data structure further includes a fourth field that indicates node identifiers of nodes that hold the content with the content name.

31. The non-transitory computer-readable medium as recited in claim 28, wherein at least one of the second field or the third field is encrypted.

32. A non-transitory computer-readable medium carrying one or more sequences of instructions for a content consumer, wherein execution of the one or more sequences of instructions by one or more processors serving as a local node in a digital communications network causes the one or more processors to:
send a request packet from a client process on the local node to a server process on a remote node for content, wherein the content comprises a plurality of chunks,
receive from the remote node a manifest packet that includes a first reliable protocol payload that indicates a name for the content, a method to decode the content after the content is delivered in coded form, and a list of chunk names and corresponding sizes of the plurality of chunks; and
send, to the server process, an interest packet that includes a second reliable protocol payload that indicates the name for the content and chunk names for one or more missing chunks of the plurality of chunks, wherein a missing chunk has not been successfully received by the client process.

33. A non-transitory computer-readable medium carrying one or more sequences of instructions for a content producer, wherein execution of the one or more sequences of instructions by one or more processors serving as a local node in a digital communications network causes the one or more processors, in response to receiving content from a server process on the local node, wherein the content comprises a plurality of chunks, to:
store the content on the local node;
generate a content name server (CNS) compatible name for the content and generating a plurality of chunk names for the plurality of chunks;
generate a manifest field that holds data that indicates the chunk names and a method of encoding of the chunks; and
send the manifest in a first reliable protocol payload to a CNS node configured to store the manifest field and store the CNS-compatible name in a content name field, and configured to reply to a request for the manifest for the CNS-compatible name with a data packet that includes the manifest field in a second reliable protocol payload and an node identifier for a node that stores the content.

34. A non-transitory computer-readable medium carrying one or more sequences of instructions for a name server, wherein execution of the one or more sequences of instructions by one or more processors serving as a local content name server (CNS) node in a digital communications network causes the one or more processors to:
receive, from a first remote node, a manifest registration packet that includes a first reliable protocol payload that indicates a CNS-compatible name for content and a manifest field, wherein the content comprises a plurality of chunks, and wherein the manifest field holds data that indicates chunk names and metadata that indicates encoding of the chunks; and
store locally in a named content delivery data structure
the CNS-compatible name in a content name field,
the manifest field in a manifest field, and
a node identifier of the first remote node in an address field.

35. A non-transitory computer-readable medium carrying one or more sequences of instructions for a content proxy, wherein execution of the one or more sequences of instructions by one or more processors serving as a local node in a digital communications network causes the one or more processors to:
receive, from a client process on a first remote node, an interest packet that includes an Internet Protocol (IP) header that indicates a different second remote node and a first reliable protocol payload that indicates a name for content, wherein the content comprises a plurality of chunks, and a transport cookie that indicates one or more missing chunks of the plurality of chunks, wherein a missing chunk has not been successfully received by the client process;
determine whether the missing chunk associated with the name for the content is stored locally;
when the missing chunk associated with the name for the content is not stored locally, then forward the interest packet to the second remote node; and
when the missing chunk associated with the name for the content is stored locally, then, instead of forwarding the interest packet to the second remote node, send to the first remote node a data delivery packet that includes a second reliable protocol payload that indicates the name for the content and the missing chunk.

36. An apparatus comprising:
at least one processor serving as a local node in a digital communications network; and
at least one memory including one or more sequences of instructions for a content consumer,
the at least one memory and the one or more sequences of instructions configured to, with the at least one processor, cause the apparatus to:
send a request packet from a client process on the local node to a server process on a remote node for content, wherein the content comprises a plurality of chunks,
receive from the remote node a manifest packet that includes a first reliable protocol payload that indicates a name for the content, a method to decode the content after the content is delivered in coded form, and a list of chunk names and corresponding sizes of the plurality of chunks; and
send, to the server process, an interest packet that includes a second reliable protocol payload that indicates the name for the content and chunk names for one or more missing chunks of the plurality of chunks, wherein a missing chunk has not been successfully received by the client process.

37. An apparatus comprising:
at least one processor serving as a local node in a digital communications network; and
at least one memory including one or more sequences of instructions for a content producer,
the at least one memory and the one or more sequences of instructions configured to, with the at least one processor, cause the apparatus, in response to receiving content from a server process on the local node, wherein the content comprises a plurality of chunks, to:
store the content on the local node;
generate a content name server (CNS) compatible name for the content and generating a plurality of chunk names for the plurality of chunks;
generate a manifest field that holds data that indicates the chunk names and a method of encoding of the chunks; and
send the manifest in a first reliable protocol payload to a CNS node configured to store the manifest field and store the CNS-compatible name in a content name field, and configured to reply to a request for the manifest for the CNS-compatible name with a data packet that includes the manifest field in a second reliable protocol payload and an node identifier for a node that stores the content.

38. An apparatus comprising:
at least one processor serving as a local content name server (CNS) node in a digital communications network; and
at least one memory including one or more sequences of instructions for content name server,
the at least one memory and the one or more sequences of instructions configured to, with the at least one processor, cause the apparatus to:
receive, from a first remote node, a manifest registration packet that includes a first reliable protocol payload that indicates a CNS-compatible name for content and a manifest field, wherein the content comprises a plurality of chunks, and wherein the manifest field holds data that indicates chunk names and metadata that indicates encoding of the chunks; and
store locally in a named content delivery data structure
the CNS-compatible name in a content name field,
the manifest field in a manifest field, and
a node identifier of the first remote node in an address field.

39. An apparatus comprising:
at least one processor serving as a local node in a digital communications network; and
at least one memory including one or more sequences of instructions for a content proxy,
the at least one memory and the one or more sequences of instructions configured to, with the at least one processor, cause the apparatus to:
receive, from a client process on a first remote node, an interest packet that includes an Internet Protocol (IP) header that indicates a different second remote node and a first reliable protocol payload that indicates a name for content, wherein the content comprises a plurality of chunks, and a transport cookie that indicates one or more missing chunks of the plurality of chunks, wherein a missing chunk has not been successfully received by the client process;
determine whether the missing chunk associated with the name for the content is stored locally;
when the missing chunk associated with the name for the content is not stored locally, then forward the interest packet to the second remote node; and
when the missing chunk associated with the name for the content is stored locally, then, instead of forwarding the interest packet to the second remote node, send to the first remote node a data delivery packet that includes a second reliable protocol payload that indicates the name for the content and the missing chunk.

40. A system comprising:
a consumer process executing on a first node in a digital communications network and configured to
send a request packet for content from a client process on the first node to a server process on a different second node in the digital communications network, wherein the content comprises a plurality of chunks,
in response to sending the request packet, receive a manifest packet that includes a first reliable protocol payload that indicates a name for the content, a node identifier for a node that stores the content, a method to decode the content after the content is delivered in coded form, and a list of chunk names of the plurality of chunks; and
send, to the node that stores the content, an interest packet that includes a second reliable protocol payload that indicates the name for the content and a chunk name for each of one or more missing chunks of the plurality of chunks, wherein a missing chunk has not been successfully received by the consumer process; and
a producer process executing on the second node and configured, in response to receiving content from the server process on the second node, to
store the content on the second node,
generate a content name server (CNS) compatible name for the content and generating a plurality of chunk names for the plurality of chunks,
generate a manifest field that holds data that indicates the plurality of chunk names and a method of encoding of the chunks, and
cause the manifest field and the CNS-compatible name to be stored and a data packet that includes the manifest field and a node identifier for the node that stores the content to be sent in the first reliable protocol payload in reply to a request for the manifest for the CNS-compatible name.

41. The system as recited in claim 40, further comprising a proxy process executing on a different third node in the digital communications network and configured to:
receive the interest packet;
determine whether the missing chunk associated with the name for the content is stored locally;
when the missing chunk associated with the name for the content is not stored locally, then forward the interest packet to the node that stores the content; and
when the missing chunk associated with the name for the content is stored locally, then, instead of forwarding the interest packet to the node that stores the content, send to the consumer process a data delivery packet that includes a third reliable protocol payload that indicates the name for the content and the missing chunk.

42. The system as recited in claim 40, wherein:
said producer process to cause the manifest field and the CNS-compatible name to be stored and the data packet that includes the manifest field and the node identifier to be sent includes to send to a content name server (CNS) process a manifest registration packet that includes the manifest field and a node identifier for the second node that stores the content and the manifest field; and
the system further comprises the CNS process executing on a different third node in the digital communications network and configured to
receive, from the producer process, the manifest registration packet, and
store locally in a named content delivery data structure
the CNS-compatible name in a content name field,
the manifest field, and
the node identifier of the second node.
